(19) United States
(12) Patent Application Publication
(10) Pub. No.: US 2026/0219525 A1
(43) Pub. Date: Jul. 30, 2026

(54) OPTICAL MODULE

(71) Applicant: HISENSE BROADBAND MULTIMEDIA TECHNOLOGIES CO., LTD., Qingdao (CN)

(72) Inventor: Yang LI, Qingdao (CN)

(21) Appl. No.: 19/630,029

(22) Filed: Mar. 26, 2026

Related U.S. Application Data
(63) Continuation of application No. PCT/CN2023/131918, filed on Nov. 16, 2023.

(30) Foreign Application Priority Data
Sep. 27, 2023 (CN) 202311258515.7
Sep. 27, 2023 (CN) 202311258609.4
Sep. 27, 2023 (CN) 202311267645.7
Sep. 27, 2023 (CN) 202311267674.3
Sep. 27, 2023 (CN) 202311269219.7

(51) Int. Cl. G02F 1/035

(52) U.S. Cl. CPC G02F 1/035

(57) ABSTRACT

An optical module including a circuit board and an optical modulation chip. The optical modulation chip includes a first and second substrates, an optical modulator, and a second coupling waveguide. A modulation driver is formed on one side of the optical modulator. A transimpedance amplifier is disposed on the first substrate. An optical demodulator is disposed on the second substrate. A first coupling waveguide is formed on one side of the optical demodulator. A first via is formed through the first substrate from an end of the optical demodulator toward the circuit board to electrically connect the optical demodulator to the circuit board; and a second via is formed through the first substrate from a bottom surface of the transimpedance amplifier toward the circuit board to electrically connect the transimpedance amplifier to the circuit board and electrically connect the optical demodulator to the transimpedance amplifier.

The present application is a continuation of International Application No. PCT/CN2023/131918, filed on November 16, 2023, which claims priority to Chinese Patent Application No. 202311258515.7, filed with the China National Intellectual Property Administration on September 27, 2023, priority to Chinese Patent Application No. 202311258609.4, filed with the China National Intellectual Property Administration on September 27, 2023, priority to Chinese Patent Application No. 202311267674.3, filed with the China National Intellectual Property Administration on September 27, 2023, priority to Chinese Patent Application No. 202311269219.7, filed with the China National Intellectual Property Administration on September 27, 2023, and priority to Chinese Patent Application No. 202311267645.7, filed with the China National Intellectual Property Administration on September 27, 2023. The entire contents of all above-mentioned applications are incorporated herein by reference.

### FIELD OF THE INVENTION

The present disclosure relates to the field of optical fiber communication technology, and in particular, to an optical module.

### BACKGROUND OF THE INVENTION

With the development of new services and application models such as cloud computing, mobile Internet, and video, advances in optical communication technology have become increasingly important. In optical communication technology, the optical module, as one of the key devices in optical communication equipment, enables the conversion between optical and electrical signals. During the development of optical communication technology, the data transmission rate of optical modules is required to continuously increase.

A coherent optical module includes a light source and a coherent assembly. The light source provides light carrying no data to the coherent assembly. The coherent assembly modulates the light carrying no data to achieve optical signal modulation. The coherent assembly can also perform demodulation of an optical signal. Therefore, a plurality of functional devices need to be integrated inside the coherent assembly, while ensuring a modulation rate.

### SUMMARY OF THE INVENTION

The present disclosure provides an optical module, including: a circuit board; an optical modulation chip, electrically connected to the circuit board, and the optical modulation chip including:

a first substrate, comprising a first groove; an optical modulator, disposed on a surface of the first substrate and configured to modulate light to be modulated based on an electrical signal; a second coupling waveguide, disposed on one side of the optical modulator and configured to transmit the light to be modulated to the optical modulator; a modulation driver, disposed on the other side of the optical modulator, electrically connected to the optical modulator, and configured to process the electrical signal; a transimpedance amplifier, disposed on the surface of the first substrate; a second substrate, at least partially embedded in the first groove; an optical demodulator, disposed on the second substrate, wrapped by the first groove, and configured to demodulate an optical signal, where the optical demodulator is disposed on one side of the transimpedance amplifier and electrically connected to the transimpedance amplifier; and a first coupling waveguide, disposed on one side of the optical demodulator, optically connected to the second coupling waveguide, and configured to transmit the light to be modulated to the second coupling waveguide, wherein a first via is formed through the first substrate in a direction from an end of the optical demodulator toward the circuit board to electrically connect the optical demodulator to the circuit board; a second via is formed through the first substrate in a direction from a bottom surface of the transimpedance amplifier toward the circuit board to electrically connect the transimpedance amplifier to the circuit board; and the first via and the second via are electrically connected through a trace in the circuit board.

### BRIEF DESCRIPTION OF THE DRAWINGS

To illustrate the technical solutions in the present disclosure more clearly, a brief introduction to the drawings used in some embodiments of the present disclosure will be provided below. Apparently, the drawings described below are merely the drawings in some embodiments of the present disclosure. Those of ordinary skill in the art can also derive other drawings from these drawings. Furthermore, the drawings described below can be regarded as schematic diagrams and are not intended to limit the actual dimensions of the products, the actual processes of the methods, or the actual timing of the signals involved in the embodiments of the present disclosure.

FIG. 1 is a partial structural diagram of an optical communication system according to some embodiments of the present disclosure;

FIG. 2 is a partial structural diagram of a host computer according to some embodiments of the present disclosure;

FIG. 3 is a structural diagram of an optical module according to some embodiments of the present disclosure;

FIG. 4 is an exploded view of an optical module according to some embodiments of the present disclosure;

FIG. 5 is a first structural diagram of an optical modulation chip according to some embodiments of the present disclosure;

FIG. 6 is a second structural diagram of an optical modulation chip according to some embodiments of the present disclosure;

FIG. 7 is an optical path diagram of an optical modulation chip according to some embodiments of the present disclosure;

FIG. 8 is a schematic diagram of the operating principle of an optical modulation chip according to some embodiments of the present disclosure;

FIG. 9 is a structural diagram of an optical modulator according to some embodiments of the present disclosure;

FIG. 10 is a top view of an optical modulator according to some embodiments of the present disclosure;

FIG. 11 is a schematic diagram of an electrical connection between an optical modulator and a modulation driver according to some embodiments of the present disclosure;

FIG. 12 is a schematic diagram of a relative positional relationship between a first coupling waveguide and a second coupling waveguide according to some embodiments of the present disclosure;

FIG. 13 is a schematic structural diagram of a first coupling waveguide according to some embodiments of the present disclosure;

FIG. 14 is a schematic structural diagram of a second coupling waveguide according to some embodiments of the present disclosure;

FIG. 15 is a schematic diagram of a relative positional relationship among a first coupling waveguide, a second coupling waveguide, and a third coupling waveguide according to some embodiments of the present disclosure;

FIG. 16 is a schematic structural diagram of a third coupling waveguide according to some embodiments of the present disclosure;

FIG. 17 is a schematic structural diagram of a first optical chip according to some embodiments of the present disclosure;

FIG. 18 is a schematic structural diagram of a second optical chip according to some embodiments of the present disclosure;

FIG. 19 is a schematic diagram of a fabrication process for a first optical chip according to some embodiments of the present disclosure; and

FIG. 20 is a schematic diagram of a fabrication process for a second optical chip according to some embodiments of the present disclosure.

### DETAILED DESCRIPTION OF THE EMBODIMENTS

The technical solutions in some embodiments of the present disclosure will be clearly and completely described below with reference to the accompanying drawings. Apparently, the described embodiments are merely some rather than all of the embodiments of the present disclosure. All other embodiments obtained by those of ordinary skill in the art based on the embodiments provided in the present disclosure fall within the scope of protection of the present disclosure.

Unless the context requires otherwise, throughout the description and claims, the term "comprise" and other forms thereof, such as the third-person singular form "comprises" and the present participle form "comprising" are construed in an open, inclusive meaning, that is, "comprising, but not limited to." In the description, the terms "one embodiment," "some embodiments," "exemplary embodiments," "example," "specific example," or "some examples," etc. are intended to indicate that a particular feature, structure, material, or characteristic related to the embodiment or example is included in at least one embodiment or example of the present disclosure. The schematic illustration of the above terms does not necessarily refer to the same embodiment or example. Furthermore, the specific features, structures, materials, or characteristics described may be included in any one or more embodiments or examples in any suitable manner.

Hereinafter, the terms "first" and "second" are configured for descriptive purposes only, and are not to be understood as indicating or implying relative importance or as implicitly indicating the number of technical features indicated. Thus, features defined with "first" and "second" may explicitly or implicitly include one or more of such features. In the description of embodiments of the present disclosure, unless otherwise specified, "a plurality" means two or more.

In describing some embodiments, the expressions "coupled" and "connected" and extensions thereof may be used. For example, in describing some embodiments, the term "connected" may be used to indicate that two or more components are in direct physical contact or electrical contact with each other. For another example, in describing some embodiments, the term "coupled" may be used to indicate that two or more components are in direct physical contact or electrical contact with each other. However, the term "coupled" or "communicatively coupled" may also indicate that two or more components are not in direct contact with each other, but still cooperate or interact with each other. The embodiments disclosed herein are not necessarily limited to the contents herein.

"At least one of A, B, and C" has the same meaning as "at least one of A, B, or C," encompassing the following combinations of A, B, and C: only A, only B, only C, a combination of A and B, a combination of A and C, a combination of B and C, as well as a combination of A, B, and C.

"A and/or B" includes three combinations of only A, only B, and a combination of A and B.

The use of "suitable for" or "configured to" herein means open and inclusive language that does not exclude devices suitable for or configured to perform additional tasks or steps.

As used herein, "about," "approximately," or "approximately" includes a stated value as well as an average within an acceptable range of deviation from a particular value, where the acceptable range of deviation is determined by one of ordinary skill in the art taking into account the measurement in question and the error associated with the measurement of a particular amount (i.e., limitations of the measurement system).

In optical communication technology, to establish information transmission between information processing devices, it is necessary to load information onto light and use the propagation of light to achieve the transmission of information. Here, the light loaded with information is an optical signal. When the optical signal is transmitted in the information transmission devices, the loss of optical power can be reduced, such that high-speed, long-distance, and low-cost information transmission can be achieved. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and third coupling waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

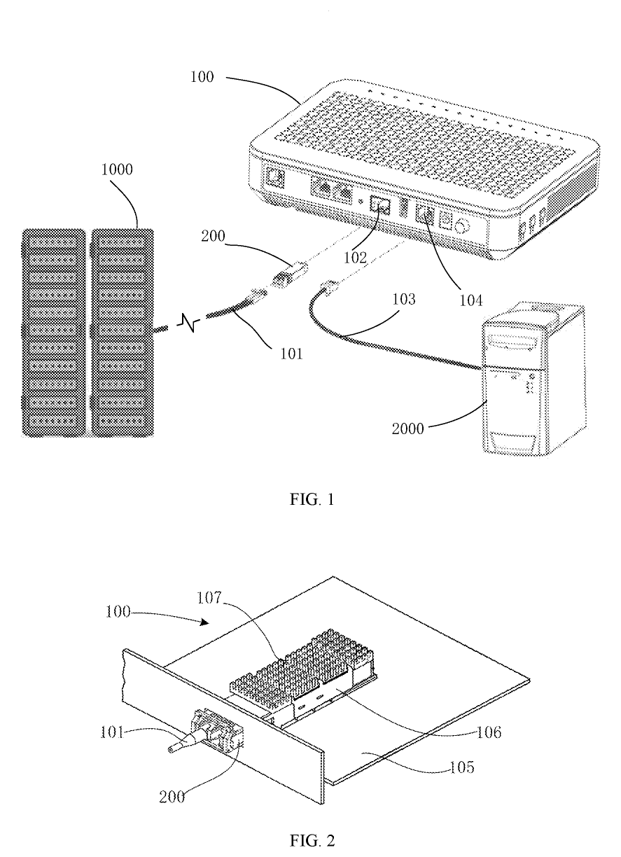

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101, and a network cable 103.

One end of the optical fiber 101 extends toward the remote information processing device 1000, and the other end of the optical fiber 101 is connected to the optical module 200 via an optical port of the optical module 200. An optical signal can undergo total reflection in the optical fiber 101, and the propagation of the optical signal in the total reflection direction can nearly maintain its original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped housing and an optical module interface 102 disposed on the housing. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted into the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to achieve the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments of the present disclosure. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 disposed in the housing, a cage 106 disposed on the surface of the PCB 105, a heat sink 107 disposed on the cage 106, and an electrical connector disposed inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. The heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, such that the optical module 200 establishes a two-way optical signal connection with the optical fiber 101.

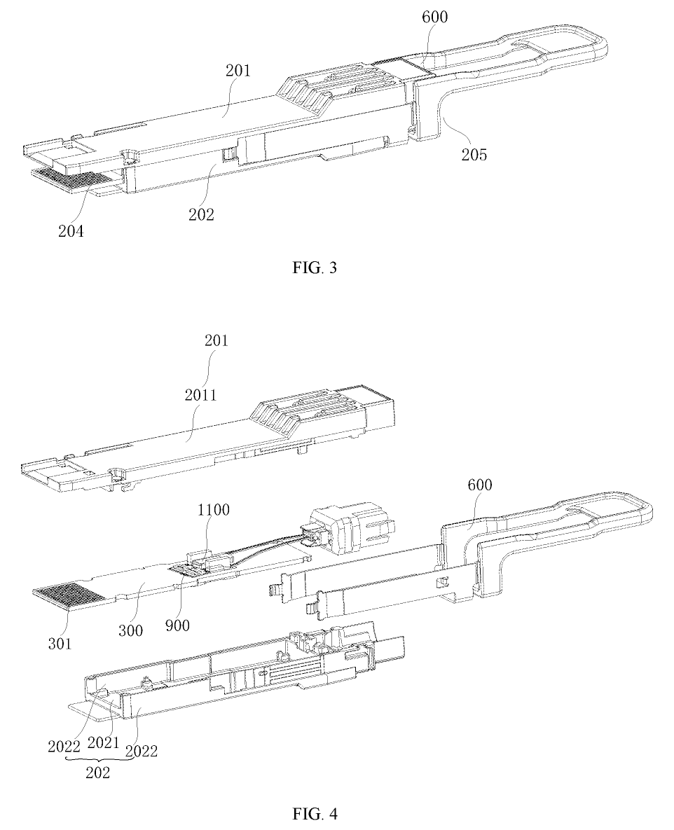

FIG. 3 is a structural diagram of an optical module according to some embodiments of the present disclosure. FIG. 4 is an exploded view of an optical module according to some embodiments of the present disclosure. As shown in FIG. 3 and FIG. 4, the optical module 200 includes a shell, and a circuit board 300, an optical modulation chip 900 and a light source 1100 that are disposed in the shell. In this case, the optical module 200 is a coherent optical module.

The housing includes an upper housing 201 and a lower housing 202, where the upper housing 201 covers the lower housing 202 to form the housing with an opening 204 and an opening 205; and the outer contour of the housing is generally square.

In some embodiments, the lower housing 202 includes a bottom plate 2021 and two lower side plates 2022 located at two sides of the bottom plate 2021 and perpendicular to the bottom plate 2021; and the upper housing 201 includes a cover plate 2011, where the cover plate 2011 covers the two lower side plates 2022 of the lower housing 202 to form the housing.

In some embodiments, the lower housing 202 includes a bottom plate 2021 and two lower side plates 2022 located at two sides of the base plate 2021 and perpendicular to the bottom plate 2021; and the upper housing 201 includes a cover plate 2011 and two upper side plates located at two sides of the cover plate 2011 and perpendicular to the cover plate 2011, where the two upper side plates and the two lower side plates 2022 are combined to ensure that the upper housing 201 covers the lower housing 202.

The direction of a connecting line between the opening 204 and the opening 205 may be consistent with the length direction of the optical module 200 or may be inconsistent with the length direction of the optical module 200. For example, the opening 204 is located at an end of the optical module 200 (the left end of FIG. 3), and the opening 205 is also located at an end of the optical module 200 (the right end of FIG. 3). Alternatively, the opening 204 is located at an end of the optical module 200, and the opening 205 is located on a side of the optical module 200. The opening 204 is an electrical port. The gold finger 301 of the circuit board 300 extends out from the opening 204 and is inserted into the electrical connector of the host computer 100. The opening 205 is an optical port, which is configured to be connected to the external optical fiber 101 such that the optical fiber 101 is connected to the optical modulation chip 900 in the optical module 200.

An assembly method of combining the upper shell 201 with the lower shell 202 is adopted, such that the circuit board 300, the optical modulation chip 900, the light source 1100, and other devices can be conveniently mounted in the shell, and these devices can be packaged by the upper shell 201 and the lower shell 202 for protection. In addition, when the circuit board 300, the optical modulation chip 900, the light source 1100, and other devices are assembled, positioning components, heat dissipation components, and electromagnetic shielding components for these devices can be deployed conveniently, thereby facilitating automated production.

In some embodiments, the upper shell 201 and the lower shell 202 are made of metal, which is conducive to electromagnetic shielding and heat dissipation.

In some embodiments, the optical module 200 further includes an unlocking component 600 located outside its shell. The unlocking component 600 is configured to achieve a fixed connection between the optical module 200 and the host computer, or to release the fixed connection between the optical module 200 and the host computer.

For example, the unlocking component 600 is located outside the two lower side plates 2022 of the lower housing 202, and includes an engaging component that matches the cage 106 of the host computer 100. When the optical module 200 is inserted into the cage 106, the optical module 200 is fixed in the cage 106 by the engaging component of the unlocking component 600; and when the unlocking component 600 is pulled, the engaging component of the unlocking component 600 moves accordingly, such that the connection relationship between the engaging component and the host computer is changed to release the fixation of the optical module 200 to the host computer, thereby pulling out the optical module 200 from the cage 106.

The circuit board 300 includes circuit traces, electronic components, and chips, where the electronic components and the chips are connected according to the circuit design through the circuit traces to implement the functions such as power supply, electrical signal transmission and grounding. The electronic components may include, for example, capacitors, resistors, transistors, and metal-oxide-semiconductor field-effect transistors (MOSFETs). The chips may include, for example, microcontroller units (MCUs), laser driving chips, transimpedance amplifiers (TIAs), limiting amplifiers, clock and data recovery (CDR) chips, power management chips, and digital signal processing (DSP) chips.

The circuit board 300 is generally a rigid circuit board. The rigid circuit board can also serve a load-bearing function because of its relatively hard material, for example, the rigid circuit board can smoothly carry the above-mentioned electronic components and chips. The rigid circuit board can also be inserted into the electrical connector in the cage 106 of the host computer 100.

The circuit board 300 further includes a gold finger 301 formed on an end surface thereof, where the gold finger 301 is composed of a plurality of mutually independent pins. The circuit board 300 is inserted into the cage 106, and the gold finger 301 is connected to the electrical connector in the cage 106. The gold finger 301 may be disposed only on the surface of a side of the circuit board 300 (e.g., the upper surface shown in FIG. 4), or may be disposed on the surfaces of the upper and lower sides of the circuit board 300 to provide more pins, so as to adapt to the occasion requiring a large number of pins. The gold finger 301 is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

The optical modulation chip 900 itself does not have a light source. The light source 1100 is used as an external light source for the optical modulation chip 900. The light source 1100 emits light (e.g., from a side surface thereof), which enters the optical modulation chip 900. For example, the light source 1100 may be a laser box, in which a laser is packaged. The laser emits a laser beam, thereby providing emitted laser light to the optical modulation chip 900.

Due to its excellent single-wavelength characteristics and superior wavelength tunability, the laser light becomes the preferred light source for optical modules and even optical fiber transmission, while other types of light such as LED light are generally not adopted in common optical communication systems. Even if such light sources are used in special optical communication systems, their characteristics and chip components differ significantly from those of the laser light, resulting in significant technical differences between optical modules using laser light and those using other light sources. Those skilled in the art will generally not consider that these two types of optical modules can give technical inspiration to each other. Certainly, the embodiments of the present disclosure do not exclude configuring the light source 1100 as other types of light such as LED light.

The light emitted by the light source 1100 is light carrying no data. The light carrying no data is light to be modulated, which enters the optical modulation chip 900. The optical modulation chip 900 modulates the light to be modulated and loads the electrical signal onto it to obtain light carrying data, i.e., an optical emission signal, thereby achieving emission of the optical signal. In addition, external light may enter the optical modulation chip 900, and the optical modulation chip 900 demodulates the external light, thereby achieving reception of the optical signal.

In some embodiments, the optical modulation chip 900 may be a silicon photonic chip, in which a modulator is integrated, and the modulator can implement modulation and demodulation of the optical signal. Since the silicon photonic chip is easy to etch, other functional devices such as an optical splitter, an optical combiner, a mixer, and an optical detector can be integrated therein, thereby achieving more functions. However, the basic characteristics of the silicon material result in defects such as low modulation efficiency, large capacitance, limited bandwidth, and high optical loss in the implementation of the optical modulator.

In some other embodiments, the optical modulation chip 900 may be a thin-film lithium niobate chip. Thin-film lithium niobate exhibits the linear electro-optic effect and other characteristics, and an applied electric field causes a linear change in the refractive index in the corresponding direction, such that the light wave transmitted in the dielectric has controllable intensity, phase, and other information. Therefore, thin-film lithium niobate may be selected as the material for the optical modulator, thereby achieving high modulation efficiency and the like.

However, the thin-film lithium niobate is relatively hard and difficult to etch, making it difficult to integrate a plurality of functional devices on its surface. Furthermore, the thin-film lithium niobate chip has a low optical loss.

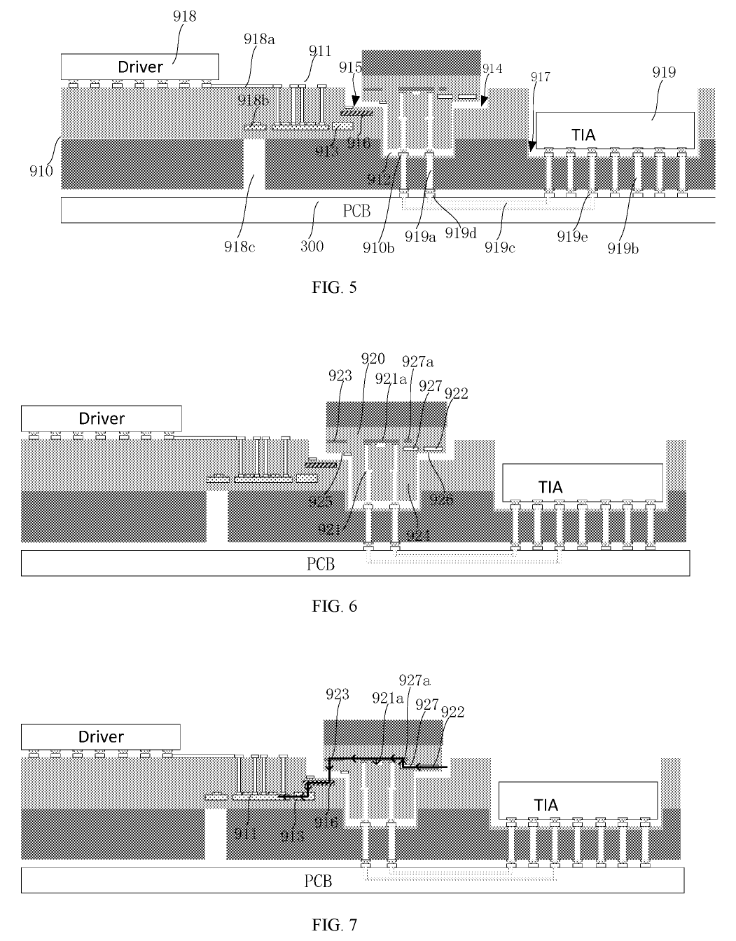

FIG. 5 is a first structural diagram of an optical modulation chip according to some embodiments of the present disclosure. FIG. 6 is a second structural diagram of an optical modulation chip according to some embodiments of the present disclosure. As shown in FIG. 5 and FIG. 6, in some embodiments of the present disclosure, the optical modulation chip 900 includes a first substrate 910. In some embodiments, the first substrate 910 is a thin-film lithium niobate-based substrate. For example, the thin-film lithium niobate-based substrate includes a silicon layer, a first silicon dioxide layer, and a thin-film lithium niobate layer that are stacked. Since thin-film lithium niobate has high modulation efficiency, an optical modulator 911 is formed on the surface of the first substrate 910, and the light to be modulated is modulated by the optical modulator 911.

Certainly, in other examples, the first substrate 910 may also be a substrate formed of other materials having characteristics such as a linear electro-optic effect, as long as the light wave transmitted in the first substrate 910 has controllable intensity, phase, and other information. The embodiments of the present disclosure do not limit the material of the first substrate 910.

The optical modulation chip 900 further includes a second substrate 920, where the second substrate 920 is disposed opposite to the first substrate 910. In some embodiments, the second substrate 920 is a silicon-based substrate. For example, the silicon-based substrate includes a first silicon layer, a silicon oxide layer, and a second silicon layer that are stacked. Since it is convenient to integrate various functional devices inside the silicon-based material, an optical demodulator 921 and other functional devices are formed on the surface of the second substrate 920, and the optical signal is demodulated by the optical demodulator 921. By way of example, the optical demodulator 921 is a photodetector, which can demodulate the optical signal into an electrical signal, thereby achieving optical signal demodulation.

Certainly, in other examples, the second substrate 920 may also be a substrate formed of other materials that are easy to etch, as long as other functional devices, such as an optical splitter, an optical combiner, a mixer, and an optical detector, can be quickly and efficiently integrated on the second substrate 920. The embodiments of the present disclosure do not limit the material of the second substrate 920.

In some embodiments, to achieve optical signal transmission, an edge coupler 922, a first coupling waveguide 923, and a first optical splitter are formed on the surface of the second substrate 920; and a second coupling waveguide 913 is formed on the surface of the first substrate 910. The edge coupler 922 is optically connected to the first coupling waveguide 923, and the first coupling waveguide 923 is optically connected to the second coupling waveguide 913, thereby achieving optical signal transmission between the surface of the second substrate 920 and the surface of the first substrate 910.

The light carrying no data, output by the light source 1100, i.e., the light to be modulated enters the surface of the second substrate 920 via the edge coupler 922, and the light carrying no data is then split into local oscillator light and a transmitter light source by the first optical splitter on the surface of the second substrate 920. The local oscillator light is transmitted into the optical demodulator 921 and is configured for coherent demodulation of the optical signal; and the transmitter light source is output along the first coupling waveguide 923 until it is coupled into the second coupling waveguide 913, thereby entering the optical modulator 911 on the surface of the first substrate 910 for optical signal modulation.

In some embodiments, to reduce the size of the optical modulation chip 900 and facilitate chip miniaturization, the second substrate 920 includes a protruding portion 924, and a first overlapping portion 925 and a second overlapping portion 926 respectively located on both sides of the protruding portion 924; and the first substrate 910 includes a first groove 912, and a second groove 915 and a third groove 914 respectively located on both sides of the first groove 912. By way of example, the protruding portion 924 protrudes from the surfaces of both the first overlapping portion 925 and the second overlapping portion 926; and the first groove 912 is recessed relative to both the second groove 915 and the third groove 914.

By way of example, the surfaces of the second groove 915 and the third groove 914 are coplanar, and the surfaces of the first overlapping portion 925 and the second overlapping portion 926 are coplanar.

By way of example, the second groove 915 and the third groove 914 are both located on one side of the first groove 912. For example, the second groove 915 and the third groove 914 are located above the first groove 912. At least part (e.g., the end) of the second substrate 920 is embedded in the first groove 912. The optical demodulator 921 is disposed on the second substrate 920 and wrapped by the first groove 912. For example, the optical demodulator 921 is disposed at the end of the second substrate 920, such that when the end of the second substrate 920 is embedded in the first groove 912, the optical demodulator 921 is wrapped by the first groove 912. That is, the first groove 912 is configured to embed the optical demodulator 921. The arrangement of the second groove 915 facilitates reducing the coupling distance between the first coupling waveguide 923 and the second coupling waveguide 913. Subsequently, by sinking the second substrate 920 to the surfaces of the second groove 915 and the third groove 914, the second substrate 920 is brought close to the first substrate 910, thereby reducing the height of the optical modulation chip 900 and further reducing the size of the optical modulation chip 900, which facilitates chip miniaturization.

In some embodiments, since the optical demodulator 921 has a certain height, in the present disclosure, the optical demodulator 921 is disposed in the protruding portion 924, the protruding portion 924 is embedded in the first groove 912, the first overlapping portion 925 overlaps the surface of the second groove 915, and the second overlapping portion 926 overlaps the surface of the third groove 914, such that the second substrate 920 is brought close to the first substrate 910, thereby reducing the height of the optical modulation chip 900 and further reducing the size of the optical modulation chip 900, which facilitates chip miniaturization. Furthermore, the coupling distance between the first coupling waveguide 923 and the second coupling waveguide 913 is shortened, thereby reducing optical loss and facilitating optical signal transmission.

By way of example, the second groove 915 is connected to the first overlapping portion 925 via optical matching adhesive, and the third groove 914 is connected to the second overlapping portion 926 via optical matching adhesive. The inner wall surface of the first groove 912 is also filled with optical matching adhesive to achieve a connection with the protruding portion 924.

In some embodiments, the edge coupler 922 is disposed on one side of the optical demodulator 921, and the edge coupler 922 is located above the second overlapping portion 926; and the first coupling waveguide 923 is disposed on the other side of the optical demodulator 921, and the first coupling waveguide 923 is located above the first overlapping portion 925. The edge coupler 922 and the first coupling waveguide 923 are respectively located at two different optical ports of the second substrate 920 to achieve optical signal transmission.

In the embodiments of the present disclosure, the optical modulator 911 is disposed on the surface of the first substrate 910. By way of example, the first substrate 910 is a thin-film lithium niobate-based substrate. The optical demodulator 921 is disposed on the surface of the second substrate 920. By way of example, the second substrate 920 is a silicon-based substrate. Furthermore, optical signal transmission is achieved via the first coupling waveguide 923 and the second coupling waveguide 913, thereby obtaining a hybrid integrated optical modulation chip. The optical modulation chip 900 of the present disclosure integrates two types of substrates, such that a plurality of functional devices can be integrated via the silicon-based substrate, and high modulation efficiency can be provided by the thin-film lithium niobate-based substrate, thereby fully utilizing the advantages of both substrates, optimizing the modulation performance of the optical modulation chip 900, and improving the coherent performance of the optical module.

In some embodiments, the edge coupler 922 is a silicon nitride coupler. To achieve optical signal coupling transmission between the edge coupler 922 and the first coupling waveguide 923, a silicon nitride optical waveguide 927 is disposed on one side of the edge coupler 922, and a silicon waveguide 927a is disposed on one side of the silicon nitride optical waveguide 927 (e.g., above the silicon nitride optical waveguide 927 in FIG. 6). The light enters the edge coupler 922 and is coupled and transmitted into the first coupling waveguide 923 sequentially via the silicon nitride optical waveguide 927, the silicon waveguide 927a, and the optical waveguide 921a of the optical demodulator 921, thereby achieving optical signal transmission between the edge coupler 922 and the first coupling waveguide 923, and transmitting the light to be modulated from the edge coupler 922 into the first coupling waveguide 923.

By way of example, the optical waveguide 921a of the optical demodulator 921 may also be a silicon waveguide. The silicon waveguide 927a, the optical waveguide 921a of the optical demodulator 921, and the first coupling waveguide 923 may be coplanar to shorten the length of the transmission path of the optical signal from the silicon waveguide 927a to the first coupling waveguide 923, reduce the refractive index and loss of the optical signal, and ensure that the optical signal can enter the first coupling waveguide 923 sequentially from the silicon waveguide 927a and the optical waveguide 921a of the optical demodulator 921. Certainly, in some examples, the height difference between any two adjacent ones of the silicon waveguide 927a, the optical waveguide 921a of the optical demodulator 921, and the first coupling waveguide 923 may be within an allowable range for low-loss optical transmission.

In some embodiments, a grating is etched on the surface of the second coupling waveguide 913 to split light at a certain ratio, thereby detecting optical power. When the second coupling waveguide 913 is a thin-film lithium niobate waveguide, it is difficult to etch the grating on the surface of the second coupling waveguide 913 due to the relatively high hardness of the thin-film lithium niobate waveguide. To this end, a third coupling waveguide 916 is further formed on one side of the second coupling waveguide 913 (e.g., above the second coupling waveguide 913 in FIG. 5). A grating is etched on the surface of the third coupling waveguide 916 to split light at a certain ratio, thereby detecting optical power.

By way of example, the third coupling waveguide 916 is an amorphous silicon optical waveguide to facilitate etching the grating. The third coupling waveguide 916 is located between the first coupling waveguide 923 and the second coupling waveguide 913. One end of the third coupling waveguide 916 faces the first coupling waveguide 923 to receive the light carrying no data, output by the first coupling waveguide 923, and the other end of the third coupling waveguide 916 faces the second coupling waveguide 913 to couple the light carrying no data into the second coupling waveguide 913. In some examples, the third coupling waveguide 916 may also be formed of other materials convenient to etch, which is not limited herein.

In the above example, the third coupling waveguide 916 is formed on the first substrate 910. In some examples, the third coupling waveguide 916 may also be disposed on the second substrate 920 and may be located between the first coupling waveguide 923 and the second coupling waveguide 913. In this way, the third coupling waveguide 916 may be made of the same material as the second substrate 920, and both of them are made of silicon, thereby facilitating fabrication of the third coupling waveguide 916.

In some embodiments, a phase modulator 918b is formed on one side of the optical modulator 911. By way of example, the phase modulator 918b is heated by a heating resistor, thereby changing the temperature of one modulation arm of the optical modulator 911. As its refractive index changes accordingly, the phase is shifted, so as to adjust the phase difference between the two modulation arms of the optical modulator 911 and further adjust the operating point of the modulator.

By way of example, the phase modulator 918b may be located on one side of the optical modulator 911 away from the second coupling waveguide 913 to mitigate or prevent the phase shifter 918b from transferring partial heat to the second coupling waveguide 913 or to the other modulation arm of the optical modulator 911, which would otherwise affect the adjustment of the phase difference.

In some embodiments, to effectively heat the phase modulator 918b, the projection region of the phase modulator 918b on the surface of the first substrate 910 is hollowed out to form a hollowed-out region 918c. This reduces heat dissipation from the surface of the first substrate 910, thereby trapping heat to a greater extent in the vicinity of the phase shifter 918b and achieving effective heating of the phase shifter 918b. In some embodiments, a soldering portion 910b is formed on the surface of the first groove 912 opposite to the optical demodulator 921, and the optical demodulator 921 is connected to the soldering portion 910b via solder joints, thereby fixing the optical demodulator 921 to the surface of the first groove 912. Certainly, in some other examples, the optical demodulator 921 may also be connected to the surface of the first groove 912 via conductive adhesive.

FIG. 7 is an optical path diagram of an optical modulation chip according to some embodiments of the present disclosure. As shown in FIG. 7 that is a transmission optical path diagram of the light to be modulated, the light enters the edge coupler 922 and is transmitted to the silicon waveguide 927a and the optical demodulator 921 via the silicon nitride optical waveguide 927. After splitting, a part of the light is left in the optical demodulator 921 for coherent demodulation, and the other part is transmitted via the optical waveguide 921a of the optical demodulator 921 and coupled into the first coupling waveguide 923, thereby achieving optical signal transmission between the edge coupler 922 and the first coupling waveguide 923, and transmitting the light to be modulated from the edge coupler 922 into the first coupling waveguide 923.

The light to be modulated continues to be transmitted via the first coupling waveguide 923 to one end of the third coupling waveguide 916, then is coupled and transmitted from the other end of the third coupling waveguide 916 into the second coupling waveguide 913, and is transmitted via the second coupling waveguide 913 to the optical modulator 911 for optical signal modulation.

The modulated optical signal returns along the original optical path until it is output via the edge coupler 922.

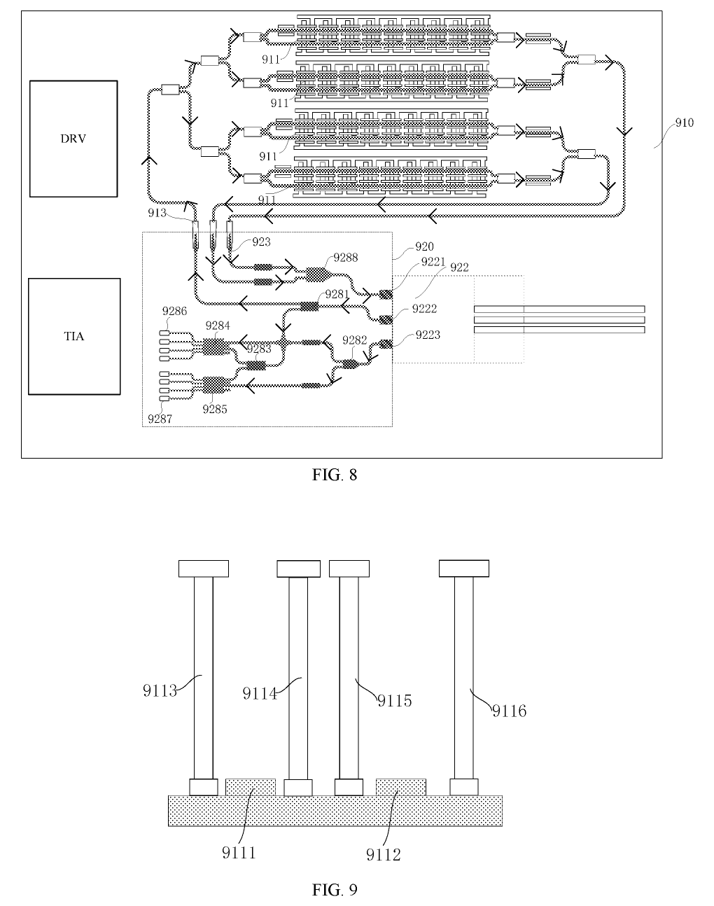

FIG. 8 is a schematic diagram of the operating principle of an optical modulation chip according to some embodiments of the present disclosure. As shown in FIG. 8, in some embodiments of the present disclosure, the second coupling waveguide 913 is formed on the surface of the first substrate 910, and the first coupling waveguide 923 is formed on the surface of the second substrate 920. The coupling of light waves between the first coupling waveguide 923 and the second coupling waveguide 913 is evanescent wave coupling, where the evanescent field of the light wave in the first coupling waveguide 923 couples with that in the second coupling waveguide 913. Based on the evanescent wave coupling principle, the second substrate 920 is mounted onto the surface of the first substrate 910 using evanescent wave coupling mounting technology, thereby obtaining the hybrid integrated optical modulation chip 900.

In addition, the edge coupler 922 formed on the surface of the second substrate 920 includes an optical output port 9221, a first optical input port 9222, and a second optical input port 9223, where the optical output port 9221 is configured to output the modulated optical signal; the first optical input port 9222 is configured to receive the light carrying no data, output by the light source 1100, i.e., the light to be modulated; and the second optical input port 9223 is configured to receive an optical signal transmitted by an external optical fiber ribbon, i.e., light to be demodulated.

In some embodiments, the surface of the second substrate 920 is further integrated with an optical demodulation unit, and the optical demodulation unit includes a plurality of functional devices. By way of example, the surface of the second substrate 920 is further respectively integrated with a first optical splitter 9281, a second optical splitter 9282, a third optical splitter 9283, a first mixer 9284, a second mixer 9285, a first detector 9286, and a second detector 9287. The first detector 9286 is the optical demodulator 921, and the second detector 9287 is configured to monitor the optical power of the received optical signal. By way of example, the second optical splitter 9282 and the third optical splitter 9283 are polarizing optical splitters.

The light carrying no data, output by the light source 1100, enters the surface of the second substrate 920 via the first optical input port 9222 and is decomposed by the first optical splitter 9281 into the local oscillator light and the transmitter light source. The local oscillator light remains inside the first detector 9286 and is configured for coherent demodulation of the optical signal. The transmitter light source is transmitted along the first coupling waveguide 923 and coupled into the second coupling waveguide 913 at a light output end of the second substrate 920 until it is transmitted to the optical modulator 911 for optical signal modulation. Therefore, in the present disclosure, the local oscillator light remains on the surface of the second substrate 920, while the transmitter light source is transmitted to the surface of the first substrate 910.

The local oscillator light is split by the third optical splitter 9283 into two optical signals with perpendicular polarization directions, i.e., first transverse electric (TE) polarized light and first transverse magnetic (TM) polarized light. When the external optical signal enters the surface of the second substrate 920, it is also split by the second optical splitter 9282 into two optical signals with perpendicular polarization directions, i.e., second TE polarized light and second TM polarized light.

The first TE polarized light and the second TE polarized light are mixed and amplified in the first mixer 9284 to obtain first mixed light. By way of example, the first mixer 9284 may be a 90° optical mixer. The first TM polarized light and the second TM polarized light are mixed and amplified in the second mixer 9285 to obtain second mixed light. The first mixed light and the second mixed light are both amplified optical signals, which are received through coherent detection. The first mixed light and the second mixed light are converted into corresponding electrical signals. After interference factors such as chromatic dispersion, noise, and nonlinearity are removed through digital signal processing, an electrical signal bitstream is recovered.

In some embodiments, the modulated optical signal, after being output from a modulation electrode, undergoes multiplexing by a multiplexer on the surface of the first substrate 910 to obtain first polarized light and second polarized light. The first polarized light and the second polarized light are transmitted along the second coupling waveguide 913 to the surface of the second substrate 920. The first polarized light and the second polarized light are combined by a polarization splitter-rotator 9288 on the surface of the second substrate 920 to obtain the optical emission signal. The optical emission signal is output via the optical output port 9221 to the exterior of the second substrate 920 and transmitted along the external optical fiber ribbon to the exterior of the optical module.

In the embodiments of the present disclosure, the modulation and demodulation of the optical signal are respectively performed on different substrates. By way of example, the modulation of the optical signal is performed on the first substrate 910, and the demodulation of the optical signal is performed on the second substrate 920, thereby avoiding mutual crosstalk of the optical signal during modulation and demodulation, and ensuring the quality of modulation and demodulation.

In the embodiments of the present disclosure, the second substrate 920 is mounted onto the surface of the first substrate 910 using the evanescent wave coupling mounting technology to obtain the hybrid integrated optical modulation chip 900. The optical modulation chip 900 can thus integrate a plurality of functional devices therein to achieve multi-functionality, and can also have high modulation efficiency, optimize modulation performance, and improve signal modulation quality.

In the embodiments of the present disclosure, the light carrying no data, output by the light source 1100, enters the surface of the second substrate 920 via the edge coupler 922, and the light carrying no data is decomposed into the local oscillator light and the transmitter light source by the third optical splitter 9283. The local oscillator light remains inside the optical demodulator 921 and is configured for coherent demodulation of the optical signal; and the transmitter light source is output along the first coupling waveguide 923 and coupled into the second coupling waveguide 913 via the third coupling waveguide 916 until it is transmitted to the optical modulator 911 for optical signal modulation. The modulated optical signal is output sequentially via the second coupling waveguide 913, the third coupling waveguide 916, the first coupling waveguide 923, and the edge coupler 922.

The edge coupler 922 transmits the light to be modulated toward the first coupling waveguide 923 via the silicon nitride optical waveguide 927 and the silicon waveguide 927a, the first coupling waveguide 923 transmits the light to be modulated toward the third coupling waveguide 916, the third coupling waveguide 916 transmits the light to be modulated toward the second coupling waveguide 913, and the second coupling waveguide 913 transmits the to-be-modulated light toward the optical modulator 911. The modulated optical signal is transmitted via the second coupling waveguide 913, the second coupling waveguide 913 transmits the modulated optical signal toward the third coupling waveguide 916, the third coupling waveguide 916 transmits the modulated optical signal toward the first coupling waveguide 923, and the first coupling waveguide 923 transmits the modulated optical signal toward the edge coupler 922.

In some embodiments of the present disclosure, the optical modulator 911 modulates the light to be modulated based on the electrical signal. By way of example, the electrical signal is loaded onto the light to be modulated, thereby being modulated into an optical signal carrying data. The optical modulator 911 has certain requirements on the amplitude and the like of the received electrical signal, so the electrical signal will undergo certain processing before entering the optical modulator 911. To this end, a modulation driver 918 is further formed on the surface of the first substrate 910. The modulation driver 918 is disposed on one side of the optical modulator 911, and the modulation driver 918 is electrically connected to the optical modulator 911. The modulation driver 918 processes the electrical signal transmitted to the optical modulator 911 to increase the amplitude of the electrical signal, such that the electrical signal meets the requirements of the optical modulator 911. The electrical signal is then loaded onto the light to be modulated via the optical modulator 911 to generate an optical emission signal carrying information.

In some embodiments, the modulation driver 918 and the optical modulator 911 are electrically connected via a metal layer 918a. By way of example, the modulation driver 918 is soldered onto the surface of the metal layer 918a in a flip-chip manner, for example, by means of ball grid array (BGA) solder balls. To shorten the length of the metal layer 918a and improve high-frequency signal transmission performance, a metal layer is laid along the top end of the optical modulator 911 to form the metal layer 918a. The metal layer 918a is laid along the surface where the end of the optical modulator 911 is located. One end of the metal layer 918a is electrically connected to the optical modulator 911, and the other end thereof is electrically connected to the modulation driver 918, thereby achieving an electrical connection between the modulation driver 918 and the optical modulator 911.

In some embodiments of the present disclosure, the optical modulation chip 900 is disposed on the surface of the circuit board 300. The optical demodulator 921 is a photodetector. The photodetector can demodulate the optical signal into an electrical signal, thereby achieving optical signal demodulation. In some embodiments, the electrical signal is further amplified by a transimpedance amplifier. To this end, a transimpedance amplifier 919 is further formed on the surface of the first substrate 910 to amplify the demodulated electrical signal. The transimpedance amplifier 919 is disposed on one side of the optical demodulator 921, and the transimpedance amplifier 919 is electrically connected to the optical demodulator 921.

Since the optical demodulator 921 is embedded in the first groove 912 and wrapped therein, no trace can be led out to achieve an electrical connection with the transimpedance amplifier 919. To this end, a first via 919a is formed through the first substrate 910 from the end of the optical demodulator 921 toward the circuit board 300. By way of example, a via is etched from the soldering portion 910b toward the surface of the circuit board 300, and the via is filled with a metal medium, thereby forming a first via 919a. The first via 919a penetrates the surface of the first substrate 910, and the first via 919a is filled with the metal medium to achieve an electrical connection between the optical demodulator 921 and the circuit board 300. That is, the optical demodulator 921 is electrically connected to the circuit board 300 through the first via 919a.

A second via 919b is formed through the first substrate 910 from the bottom surface of the transimpedance amplifier 919 toward the circuit board 300. By way of example, a via is etched from the bottom surface of the transimpedance amplifier 919 toward the circuit board 300, and the via is filled with a metal medium, thereby forming a second via 919b. The second via 919b penetrates the surface of the first substrate 910, and the second via 919b is filled with the metal medium to achieve an electrical connection between the transimpedance amplifier 919 and the circuit board 300. That is, the transimpedance amplifier 919 is electrically connected to the circuit board 300 through the second via 919b.

The end of the first via 919a is provided with a first connection portion 919d on the surface of the circuit board 300, and the end of the second via 919b is provided with a second connection portion 919e on the surface of the circuit board 300. The first connection portion 919d is electrically connected to the second connection portion 919e, thereby achieving an electrical connection between the optical demodulator 921 and the transimpedance amplifier 919. In some embodiments, the first connection portion 919d is electrically connected to the second connection portion 919e via a trace 919c.

By way of example, the first connection portion 919d is a first pad, and the second connection portion 919e is a second pad. The first pad and the second pad are electrically connected via the trace 919c, thereby achieving the electrical connection between the optical demodulator 921 and the transimpedance amplifier 919.

In some embodiments, the first via 919a and the second via 919b are formed by etching the vias and depositing metal in the vias. To unify the depths of the etched vias and the thicknesses of the deposited metals in two electrical channels and facilitate fabrication, a fourth groove 917 is further formed on the surface of the first substrate 910. The transimpedance amplifier 919 is disposed on the surface of the fourth groove 917. By way of example, the transimpedance amplifier 919 is soldered onto the surface of the fourth groove 917 in a flip-chip manner, for example, by means of BGA solder balls.

By way of example, when the distance from the fourth groove 917 to the bottom surface of the first substrate 910 is the same as that from the first groove 912 to the bottom surface of the first substrate 910, that is, the top surface of the fourth groove 917 is flush with the plane where the top surface of the first groove 912 is located, it can be ensured that the depths of the etched vias and the thicknesses of the deposited metal in the two electrical channels are the same, thereby simplifying the fabrication process.

In addition, the material between the fourth groove 917 and the bottom surface of the first substrate 910 and the material between the first groove 912 and the bottom surface of the first substrate 910 may be the same, for example, a silicon layer, which can also simplify the fabrication process.

In the present disclosure, the modulation driver 918 and the transimpedance amplifier 919 are disposed on the surface of the first substrate 910, such that the modulation driver 918 and the transimpedance amplifier 919 are integrated inside the optical modulation chip 900, thereby saving space for the circuit board 300. Furthermore, the distance between the modulation driver 918 and the optical modulator 911, and the distance between the optical demodulator 921 and the transimpedance amplifier 919 can be shortened, thereby facilitating signal transmission.

Certainly, in some other embodiments of the present disclosure, the modulation driver 918 is disposed on the surface of the circuit board 300, and the modulation driver 918 is connected to the optical modulator 911 by wire bonding. In some embodiments of the present disclosure, the transimpedance amplifier 919 is disposed on the surface of the circuit board 300, and a via is then etched from the surface of the first substrate 910 on the bottom surface of the first groove 912 toward the circuit board 300 to form an electrical channel, which achieves the electrical connection between the optical demodulator 921 and the circuit board 300. Furthermore, the electrical channel is provided with a pad on the surface of the circuit board 300. The pad is connected to the transimpedance amplifier 919 by wire bonding, thereby achieving the electrical connection between the optical demodulator 921 and the transimpedance amplifier 919.

In some embodiments of the present disclosure, when the optical modulator 911 is a silicon-based modulator, the optical modulator 911 includes a first S modulation electrode, a G modulation electrode, and a first S modulation electrode, where a ridge waveguide is disposed between the first S modulation electrode and the G modulation electrode, and a ridge waveguide is disposed between the G modulation electrode and the first S modulation electrode. During operation, when the modulation driver 918 is a differential driver, the modulation driver 918 has a first output terminal and a second output terminal, where the first output terminal and the second output terminal respectively output a differential signal S+ and a differential signal S-, and the signal amplitude between the two differential signals is Vs. The differential signal S+ and the differential signal S- are applied to the first S modulation electrode and the second S modulation electrode, respectively. Since the applied signals have the same amplitude but opposite phases, the refractive index changes in the materials on the two arms are opposite, resulting in a phase difference of 2·Vs. Accordingly, the optical modulation amplitude (OMA) is given by OMA = Vs - (-Vs) = 2Vs.

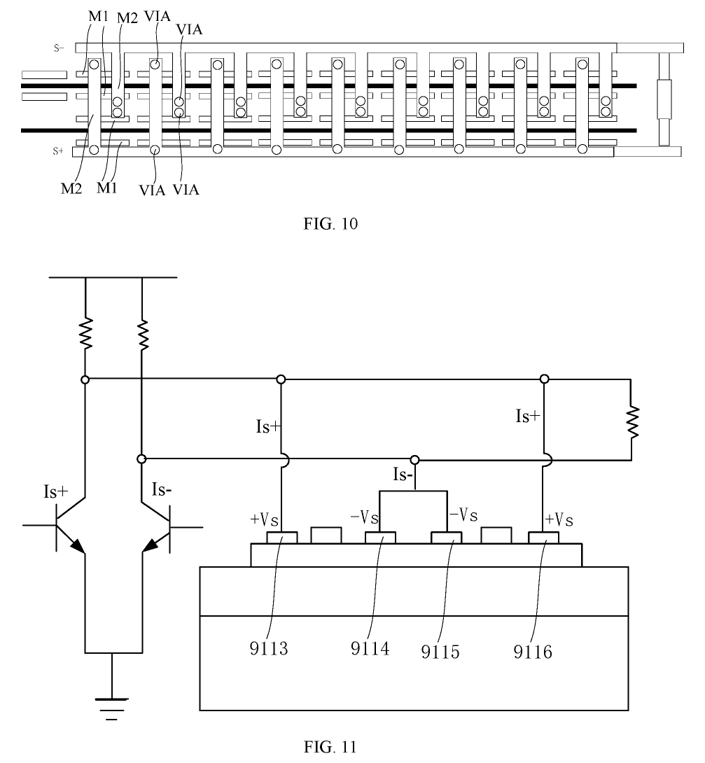

FIG. 9 is a structural diagram of an optical modulator according to some embodiments of the present disclosure. FIG. 10 is a top view of an optical modulator according to some embodiments of the present disclosure. As shown in FIG. 9 and FIG. 10, in some embodiments of the present disclosure, the optical modulator 911 is a thin-film lithium niobate-based modulator. The optical modulator 911 includes a first ridge waveguide 9111 and a second ridge waveguide 9112, and further includes a first differential modulation electrode 9113, a second differential modulation electrode 9114, a third differential modulation electrode 9115, and a fourth differential modulation electrode 9116. The first differential modulation electrode 9113 is located on one side of the first ridge waveguide 9111, the second differential modulation electrode 9114 and the third differential modulation electrode 9115 are located between the other side of the first ridge waveguide 9111 and one side of the second ridge waveguide 9112, and the fourth differential modulation electrode 9116 is located on the other side of the second ridge waveguide 9112. Both ends of the first differential modulation electrode 9113 are respectively provided with a first metal layer M1 and a second metal layer M2, and the first metal layer M1 and the second metal layer M2 are electrically connected through a via VIA. Both ends of the second differential modulation electrode are also respectively provided with a first metal layer and a second metal layer, and the first metal layer and the second metal layer are electrically connected through a via. The same applies to the third differential modulation electrode and the fourth differential modulation electrode.

When the modulation driver 918 is a differential driver, the modulation driver 918 has a first differential output terminal and a second differential output terminal, where the first differential output terminal and the second differential output terminal respectively output a differential signal S+ and a differential signal S-, and the signal amplitude between the two differential signals is Vs. The differential signal S- is respectively transmitted to the second differential modulation electrode and the third differential modulation electrode, and the differential signal S+ is respectively transmitted to the first differential modulation electrode and the fourth differential modulation electrode, thereby forming two pairs of differential traveling-wave electrodes.

FIG. 11 is a schematic diagram of an electrical connection between an optical modulator and a modulation driver according to some embodiments of the present disclosure. As shown in FIG. 11, in some embodiments of the present disclosure, the first differential output terminal of the modulation driver 918 is respectively electrically connected to the first differential modulation electrode 9113 and the fourth differential modulation electrode 9116, and the second differential output terminal is respectively electrically connected to the second differential modulation electrode 9114 and the third differential modulation electrode 9115. Accordingly, the differential signal received by the first differential modulation electrode 9113 is +Vs, the differential signal received by the second differential modulation electrode 9114 is -Vs, the differential signal received by the third differential modulation electrode 9115 is -Vs, and the differential signal received by the fourth differential modulation electrode 9116 is +Vs. The first differential modulation electrode 9113 and the second differential modulation electrode 9114 constitute a pair of differential traveling-wave electrodes, and the third differential modulation electrode 9115 and the fourth differential modulation electrode 9116 constitute the other pair of differential traveling-wave electrodes.

In this case, the optical modulation amplitude is given by OMA = Vs - (-Vs) - (-(Vs-(-Vs))) = 4·Vs. It can be seen that when the optical modulator 911 is a thin-film lithium niobate-based modulator and the modulation driver 918 is a differential driver, the OMA is 4·Vs; and when the optical modulator 911 is a silicon-based modulator and the modulation driver 918 is a differential driver, the OMA is 2·Vs.

In the present disclosure, when the optical modulator 911 is a thin-film lithium niobate-based modulator and the modulation driver 918 is a differential driver, the OMA can be increased, and in a case where the driver power is the same, the OMA of the lithium niobate-based modulator can be increased to 4·Vs. A larger OMA can reduce the bit error rate at the receiver of the system, thereby improving optical reception performance.

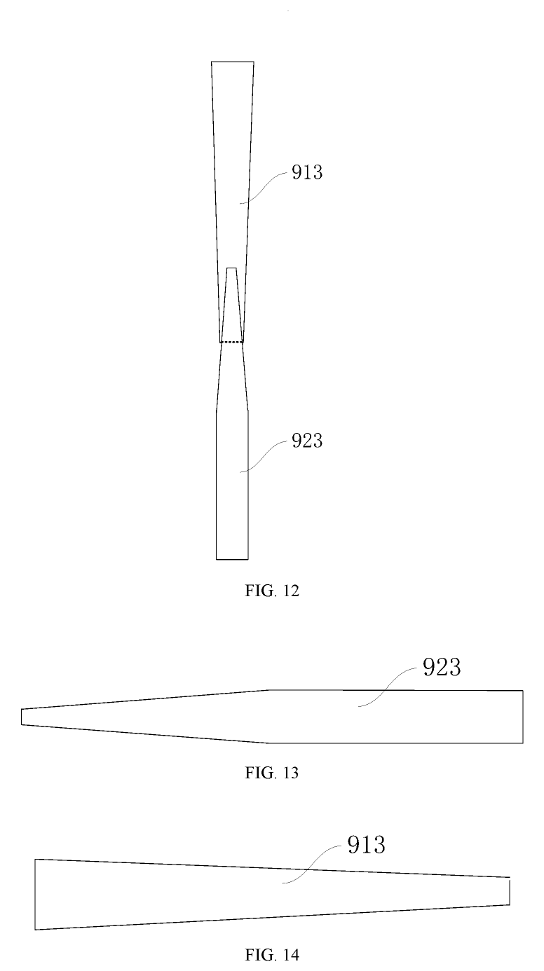

FIG. 12 is a schematic diagram of a relative positional relationship between a first coupling waveguide and a second coupling waveguide according to some embodiments of the present disclosure. As shown in FIG. 12, in some embodiments of the present disclosure, both the first coupling waveguide 923 and the second coupling waveguide 913 are tapered waveguides. By way of example, when the second substrate 920 is a silicon-based substrate, the first coupling waveguide 923 is a silicon optical waveguide; and when the first substrate 910 is a thin-film lithium niobate-based substrate, the second coupling waveguide 913 is a lithium niobate optical waveguide. Since the refractive index of the silicon optical waveguide is greater than that of the lithium niobate optical waveguide, to ensure that more light is coupled from the silicon optical waveguide into the lithium niobate optical waveguide, or to ensure that more light enters the silicon optical waveguide from the lithium niobate optical waveguide, both the first coupling waveguide 923 and the second coupling waveguide 913 are configured as tapered waveguides.

By way of example, the first coupling waveguide 923 and the second coupling waveguide 913 are both tapered waveguides including tapered sections, thereby changing the effective refractive indices of their respective modes and altering the optical field distribution, such that more light is coupled from the first coupling waveguide 923 into the second coupling waveguide 913, or from the second coupling waveguide 913 into the first coupling waveguide 923. By way of example, the width of the first coupling waveguide 923 gradually decreases from a light input end to a light output end, and then the effective refractive index of its mode gradually decreases. The width of the second coupling waveguide 913 gradually increases from a light input end to a light output end, and then the effective refractive index of its mode gradually increases, such that more light is coupled from the first coupling waveguide 923 into the second coupling waveguide 913, thereby improving the coupling efficiency.

It should be noted that the light input end or the light output end of the first coupling waveguide 923 or the second coupling waveguide 913 mentioned above is named by taking the transmission direction of the optical signal coupled from the first coupling waveguide 923 to the second coupling waveguide 913 as an example. In this way, after being modulated, the optical signal enters the second coupling waveguide 913 via the light output end of the second coupling waveguide 913, is coupled to the light output end of the first coupling waveguide 923 via the light input end of the second coupling waveguide 913, then enters the interior of the first coupling waveguide 923, and finally is transmitted into the edge coupler 922 via the light input end of the first coupling waveguide 923.

The following will also be described by taking the transmission direction of the optical signal coupled from the first coupling waveguide 923 to the second coupling waveguide 913 as an example.

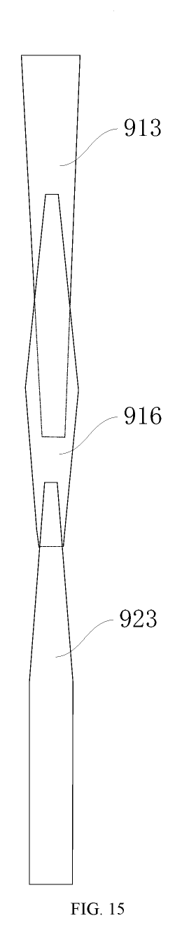

FIG. 13 is a schematic structural diagram of a first coupling waveguide according to some embodiments of the present disclosure. FIG. 14 is a schematic structural diagram of a second coupling waveguide according to some embodiments of the present disclosure. As shown in FIG. 13 and FIG. 14, the widths of the first coupling waveguide 923 and the second coupling waveguide 913 vary in opposite directions. By varying the respective widths, it is intended to reduce the effective refractive index of the mode of the first coupling waveguide 923 while increasing the effective refractive index of the mode of the second coupling waveguide 913, thereby altering the optical field distribution, such that more light is coupled from the first coupling waveguide 923 into the second coupling waveguide 913, thus improving the coupling efficiency.

The cross section of the first coupling waveguide 923 is composed of a rectangular waveguide and a tapered waveguide as a tapered section thereof, transitioning from the rectangular waveguide to the tapered waveguide. The large width of the rectangular waveguide can improve the coupling efficiency from the edge coupler 922 to the second substrate 920, thereby increasing the output optical power on the surface of the second substrate 920. The gradually decreasing width of the tapered waveguide allows the optical field to transfer to the second coupling waveguide 913, such that more light is coupled from the first coupling waveguide 923 into the second coupling waveguide 913.

The cross section of the second coupling waveguide 913 gradually changes in width, and its width increases from the light input end to the light output end, aiming to receive more light output by the first coupling waveguide 923 while increasing the output optical power of the second coupling waveguide 913.

It can be understood that the present disclosure does not limit the specific shapes of the first coupling waveguide 923 and the second coupling waveguide 913, and any corresponding shapes that allow more light to be coupled from the first coupling waveguide 923 into the second coupling waveguide 913 are within the scope of protection of the present disclosure.

For example, the shape of the second coupling waveguide 913 may also be similar to that of the first coupling waveguide 923. For example, the cross section of the second coupling waveguide 913 may also be composed of a rectangular waveguide and a tapered waveguide as a tapered section thereof, transitioning from the tapered waveguide to the rectangular waveguide. The large width of the rectangular waveguide can improve the coupling efficiency from the second coupling waveguide 913 to the optical modulator 911. The gradually decreasing width of the tapered waveguide allows the optical field to transfer to the first coupling waveguide 923, such that more light emitted from the first coupling waveguide 923 is coupled into the second coupling waveguide 913, thereby increasing the output optical power on the surface of the second substrate 920.

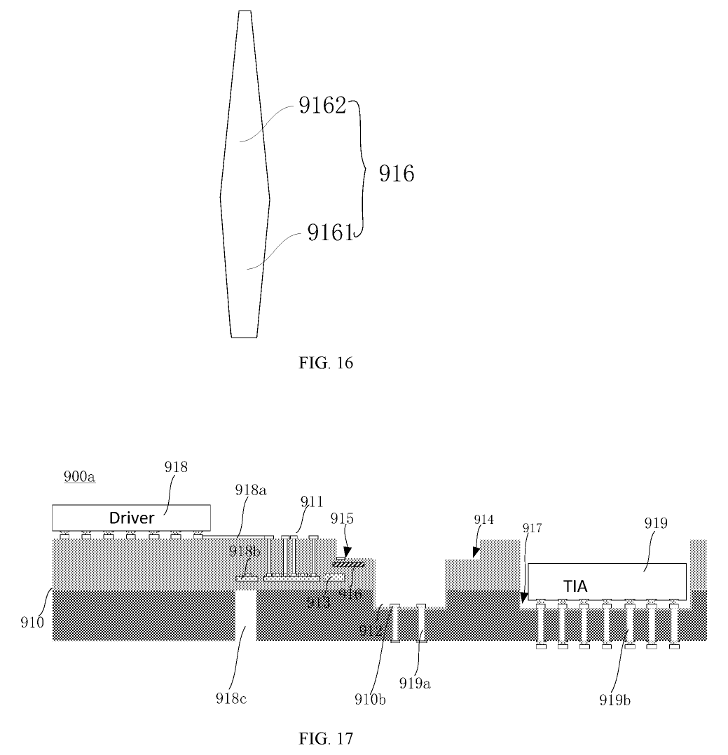

FIG. 15 is a schematic diagram of a relative positional relationship among a first coupling waveguide, a second coupling waveguide, and a third coupling waveguide according to some embodiments of the present disclosure. FIG. 16 is a schematic structural diagram of a third coupling waveguide according to some embodiments of the present disclosure. As shown in FIG. 15 and FIG. 16, it can be seen from the above that a third coupling waveguide 916 is disposed between the first coupling waveguide 923 and the second coupling waveguide 913. A grating is etched on the surface of the third coupling waveguide 916 to split light at a certain ratio, thereby detecting optical power. One end of the third coupling waveguide 916 faces the first coupling waveguide 923, and the other end thereof faces the second coupling waveguide 913.

From a top view, the first coupling waveguide 923, the third coupling waveguide 916, and the second coupling waveguide 913 are arranged in sequence from top to bottom. The light carrying no data, output from the edge coupler 922, is coupled to the surface of the second substrate 920, transmitted along the first coupling waveguide 923, and output from the surface of the second substrate 920. Then, the light is coupled into the third coupling waveguide 916, transmitted along the third coupling waveguide 916, and coupled into the second coupling waveguide 913 until it is transmitted into the optical modulator 911 for optical signal modulation. The modulated optical signal is output from the surface of the second substrate 920 sequentially along the second coupling waveguide 913, the third coupling waveguide 916, the first coupling waveguide 923, and the edge coupler 922, and then transmitted to the exterior of the optical module via the external optical fiber ribbon to achieve optical signal emission.

Since the refractive index of the silicon optical waveguide is greater than that of the lithium niobate optical waveguide, to ensure that more light is coupled from the first coupling waveguide 923 into the third coupling waveguide 916 and more light is coupled from the third coupling waveguide 916 into the first coupling waveguide 923, the third coupling waveguide 916 includes a first tapered region 9161 and a second tapered region 9162, where the first tapered region 9161 faces the first coupling waveguide 923, and the second tapered region 9162 faces the second coupling waveguide 913. The waveguide width of the first tapered region 9161 gradually increases from a light input end to a light output end to match the first coupling waveguide 923 whose width gradually decreases from the light input end to the light output end, such that more light is coupled from the first coupling waveguide 923 into the third coupling waveguide 916. The waveguide width of the second tapered region 9162 gradually decreases from a light input end to a light output end to match the second coupling waveguide 913 whose width gradually increases from the light input end to the light output end, such that more light is coupled from the third coupling waveguide 916 into the second coupling waveguide 913, thereby achieving coupling of the light carrying no data from the first coupling waveguide 923 into the second coupling waveguide 913 until it is transmitted into the optical modulator 911 for optical signal modulation.

During configuration, there may be a rectangular section between the first tapered region 9161 and the second tapered region 9162. Certainly, in some examples, the light output end of the first tapered region 9161 is directly connected to the light input end of the second tapered region 9162.

It can be understood that the present disclosure does not limit the specific shape of the third coupling waveguide 916, and any corresponding shapes that allow light to be coupled from the first coupling waveguide 923 to the second coupling waveguide 913 are within the scope of protection of the present disclosure.

Based on the optical modulation chip 900 provided in the above embodiment, the modulation and demodulation of the optical signal can be achieved, which are performed on two different substrates respectively to avoid crosstalk between optical signals. In some embodiments, the first substrate 910 and various devices on the surface of the first substrate 910 are integrated into a first optical chip 900a, and the second substrate 920 and various devices on the surface of the second substrate 920 are integrated into a second optical chip 900b. The first optical chip 900a and the second optical chip 900b are integrated to obtain the optical modulation chip 900. The optical modulation chip 900 in the present disclosure integrates two types of optical chips, thereby making full use of the advantages of the two types of optical chips.

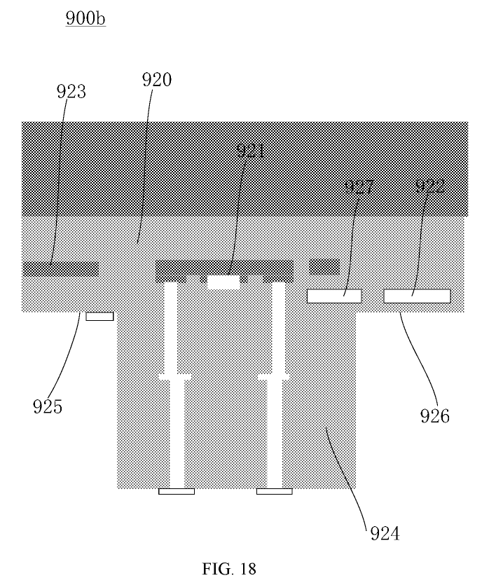

FIG. 17 is a schematic structural diagram of a first optical chip according to some embodiments of the present disclosure. As shown in FIG. 17, in some embodiments of the present disclosure, the first optical chip 900a includes a first substrate 910. The surface of the first substrate 910 is provided with a first groove 912, and a second groove 915 and a third groove 914 are respectively formed on both sides of the first groove 912. The first substrate 910 is a thin-film lithium niobate-based substrate, and correspondingly, the first optical chip 900a is a thin-film lithium niobate chip.

In some embodiments, an optical modulator 911 is formed on the surface of the first substrate 910, a second coupling waveguide 913 is formed on one side of the optical modulator 911, and a third coupling waveguide 916 is formed above the second coupling waveguide 913. The light to be modulated is sequentially transmitted via the third coupling waveguide 916 and the second coupling waveguide 913 to the optical modulator 911 for optical signal modulation. The modulated optical signal is output from the first optical chip 900a sequentially via the second coupling waveguide 913 and the third coupling waveguide 916.

In some embodiments, a phase modulator 918b is formed on one side of the optical modulator 911. The phase modulator 918b is heated, thereby changing the temperature of one modulation arm of the optical modulator 911. As its refractive index changes accordingly, the phase is shifted, so as to adjust the phase difference between the two modulation arms of the optical modulator 911 and further adjust the operating point of the modulator.

In some embodiments, to effectively heat the phase modulator 918b, the projection region of the phase modulator 918b on the surface of the first substrate 910 is hollowed out to form a hollowed-out region 918c. This prevents heat dissipation from the surface of the first substrate 910, thereby trapping heat in the vicinity of the phase shifter 918b and achieving effective heating of the phase shifter 918b.

In some embodiments, a modulation driver 918 is further formed on the surface of the first substrate 910. The modulation driver 918 is disposed on one side of the optical modulator 911, and the modulation driver 918 is electrically connected to the optical modulator 911. The modulation driver 918 processes the electrical signal transmitted to the optical modulator 911 to increase the amplitude of the electrical signal, such that the electrical signal meets the requirements of the optical modulator 911. The electrical signal is then loaded onto the light to be modulated via the optical modulator 911 to generate an optical emission signal carrying information.

In some embodiments, the modulation driver 918 and the optical modulator 911 are electrically connected via a metal layer 918a. To shorten the length of the metal layer 918a and improve high-frequency signal transmission performance, a metal layer is laid along the top end of the optical modulator 911 to form the metal layer 918a. The metal layer 918a is laid along the surface where the end of the optical modulator 911 is located. One end of the metal layer 918a is electrically connected to the optical modulator 911, and the other end thereof is electrically connected to the modulation driver 918, thereby achieving the electrical connection between the modulation driver 918 and the optical modulator 911.

In some embodiments, a transimpedance amplifier 919 is further formed on the surface of the first substrate 910 to amplify the demodulated electrical signal. The transimpedance amplifier 919 is disposed on one side of the optical demodulator 921 and electrically connected to the optical demodulator.

Since the optical demodulator 921 is embedded in the first groove 912 and wrapped therein, no trace can be led out to achieve an electrical connection with the transimpedance amplifier 919. To this end, a via is etched from the projection region of the optical demodulator 921 on the surface of the first groove 912 toward the surface of the circuit board 300 to form a first via 919a.

By way of example, the first via 919a penetrates the surface of the first substrate 910, and the first via 919a is filled with the metal medium to achieve an electrical connection between the optical demodulator 921 and the circuit board 300. That is, the optical demodulator 921 is electrically connected to the circuit board 300 through the first via 919a. Furthermore, a via is etched from the surface of the first substrate 910 where the transimpedance amplifier 919 is located toward the surface of the circuit board 300 to form a second via 919b. By way of example, the second via 919b penetrates the surface of the first substrate 910, and the second via 919b is filled with the metal medium to achieve an electrical connection between the transimpedance amplifier 919 and the circuit board 300. That is, the transimpedance amplifier 919 is electrically connected to the circuit board 300 through the second via 919b. Referring to FIG. 5, during configuration, the end of the first via 919a may be provided with a first connection portion 919d on the surface of the circuit board 300, and the end of the second via 919b may be provided with a second connection portion 919e on the surface of the circuit board 300. The first connection portion 919d and the second connection portion 919e are electrically connected, thereby achieving the electrical connection between the optical demodulator 921 and the transimpedance amplifier 919. The arrangement of the first connection portion 919d achieves rapid positioning of the first via 919a in the circuit board 300 and also improves the electrical connection stability of the first via 919a in the circuit board 300. Similarly, the arrangement of the second connection portion 919e achieves rapid positioning of the second via 919b in the circuit board 300 and also improves the electrical connection stability of the second via 919b in the circuit board 300.

In some embodiments, the first connection portion 919d is electrically connected to the second connection portion 919e via a trace 919c. By way of example, the first connection portion 919d is a first pad, and the second connection portion 919e is a second pad. The first pad and the second pad are electrically connected via the trace 919c in the circuit board 300, thereby achieving the electrical connection between the optical demodulator 921 and the transimpedance amplifier 919. It can be understood that the trace 919c in the circuit board 300 is prefabricated during fabrication of the circuit board 300, that is, a plurality of mutually insulated metal traces are formed at intervals in the circuit board 300, and both ends of at least some of the metal traces respectively extend to the surface of the circuit board 300 to be electrically connected to various devices on the surface of the circuit board 300, such as the pads of the present disclosure.

Certainly, in some examples, the first via 919a may be directly soldered to the circuit board 300, and the end of the second via 919b may be directly soldered to the circuit board 300, such that the first via 919a and the second via 919b are electrically connected through the circuit board 300.

In some embodiments, the first via 919a and the second via 919b are formed by etching the vias and depositing metal in the vias. To unify the depths of the etched vias and the thicknesses of the deposited metals in two electrical channels and facilitate fabrication, a fourth groove 917 is further formed on the surface of the first substrate 910. The transimpedance amplifier 919 is disposed on the surface of the fourth groove 917.

By way of example, when the distance from the fourth groove 917 to the bottom surface of the first substrate 910 is the same as that from the first groove 912 to the bottom surface of the first substrate 910, it can be ensured that the depths of the etched vias and the thicknesses of the deposited metal in the two electrical channels are the same, thereby simplifying the fabrication process. FIG. 18 is a schematic structural diagram of a second optical chip according to some embodiments of the present disclosure. As shown in FIG. 18, in some embodiments of the present disclosure, the second optical chip 900b includes a second substrate 920. The second substrate 920 is a silicon-based substrate, and correspondingly, the second optical chip 900b is a silicon photonic chip.

The second substrate 920 includes a protruding portion 924, and a first overlapping portion 925 and a second overlapping portion 926 respectively located on both sides of the protruding portion 924. In some embodiments, the protruding portion 924 is embedded in the first groove 912, the first overlapping portion 925 overlaps the surface of the second groove 915, and the second overlapping portion 926 overlaps the surface of the third groove 914, such that the second substrate 920 is brought close to the first substrate 910, thereby reducing the height of the optical modulation chip 900 and further reducing the size of the optical modulation chip 900, which facilitates chip miniaturization.

In some embodiments, an optical demodulator 921 is disposed in the protruding portion 924. The optical demodulator 921 is embedded in the first groove 912. A soldering portion 910b is formed on the surface of the first groove 912 opposite to the optical demodulator 921, and the end of the optical demodulator 921 is connected to the soldering portion 910b via solder joints, thereby fixing the optical demodulator 921 to the surface of the first groove 912.

In some embodiments, to achieve optical signal transmission, an edge coupler 922 and a first coupling waveguide 923 are formed on the surface of the second substrate 920, and a first optical splitter is further formed on the surface of the second substrate 920; and a second coupling waveguide 913 is formed on the surface of the first substrate 910. The edge coupler 922 is optically connected to the first coupling waveguide 923, and the first coupling waveguide 923 is optically connected to the second coupling waveguide 913, thereby achieving optical signal transmission between the surface of the second substrate 920 and the surface of the first substrate 910.

By way of example, the edge coupler 922 is a silicon nitride coupler. To achieve optical signal coupling transmission between the edge coupler 922 and the first coupling waveguide 923, a silicon nitride optical waveguide 927 is disposed on one side of the edge coupler 922, and a silicon waveguide 927a is disposed above the silicon nitride optical waveguide 927. The light enters the edge coupler 922 and is coupled and transmitted into the first coupling waveguide 923 sequentially via the silicon nitride optical waveguide 927, the silicon waveguide 927a, and the optical waveguide 921a of the optical demodulator 921, thereby achieving optical signal transmission between the edge coupler 922 and the first coupling waveguide 923, and transmitting the light to be modulated from the edge coupler 922 into the first coupling waveguide 923.

In some embodiments of the present disclosure, the protruding portion 924 of the first optical chip 900a is embedded in the first groove 912, the first overlapping portion 925 overlaps the surface of the second groove 915, and the second overlapping portion 926 overlaps the surface of the third groove 914, such that the second optical chip 900b is brought close to the first optical chip 900a, thereby reducing the height of the optical modulation chip 900 and further reducing the size of the optical modulation chip 900, which facilitates chip miniaturization. Furthermore, the coupling distance between the first coupling waveguide 923 and the second coupling waveguide 913 is shortened, thereby reducing optical loss and facilitating optical signal transmission.

In the embodiments of the present disclosure, the light to be modulated enters the interior of the second optical chip 900b from the corresponding optical port of the edge coupler 922, is transmitted to the interior of the first optical chip 900a sequentially via the silicon nitride optical waveguide 927, the silicon waveguide 927a, the optical waveguide 921a of the optical demodulator 921, the first coupling waveguide 923, the third coupling waveguide 916, and the second coupling waveguide 913, and reaches the optical modulator 911 for optical signal modulation. The modulated optical signal sequentially passes through the second coupling waveguide 913, the third coupling waveguide 916, the first coupling waveguide 923, and the silicon nitride optical waveguide 927, and is then output from the first optical chip 900a via the edge coupler 922.

In the embodiments of the present disclosure, for details in the specific implementation process for hybrid integration of the first optical chip 900a and the second optical chip 900b, reference can be made to the specific implementation process for the optical modulation chip 900 shown in the embodiment of FIG. 5.

In some embodiments of the present disclosure, a fabrication process for an optical modulation chip 900 includes:

forming a second coupling waveguide 913 and a ridge waveguide of an optical modulator 911 by etching along the surface of a first substrate 910; forming a third coupling waveguide 916 above the second coupling waveguide 913, and forming a first etch stop layer above the third coupling waveguide 916; etching from the top surface of the first substrate 910 down to the first etch stop layer, thereby respectively forming a second groove 915 and a third groove 914; then forming a first groove 912 by etching along the bottom surface of the second groove 915; forming the optical modulator 911 by growth along the ridge waveguide of the optical modulator;

forming a first coupling waveguide 923 and a local structure of an optical demodulator by etching along the surface of a second substrate 920; forming a second etch stop layer above the first coupling waveguide 923; furthermore, continuing to grow the optical demodulator 921 along the local structure of the optical demodulator to form the optical demodulator 921; etching from the top surface of the second substrate 920 down to the second etch stop layer, thereby respectively forming a protruding portion 924, a first overlapping portion 925, and a second overlapping portion 926; and

disposing the protruding portion 924 in the first groove 912, overlapping the first overlapping portion 925 on the second groove 915, and overlapping the second overlapping portion 926 on the third groove 914, thereby obtaining the optical modulation chip 900.

In some embodiments, when the second coupling waveguide 913 and the ridge waveguide of the optical modulator are formed by etching along the surface of the first substrate 910, a phase modulator 918b is formed on one side of the ridge waveguide. When the optical modulator is formed by growth along the ridge waveguide of the optical modulator, a hollowed-out region 918c is formed in a region of the first substrate corresponding to the phase modulator 918b.

In some embodiments, when the second etch stop layer is formed above the first coupling waveguide 923, a silicon nitride optical waveguide 927, a silicon waveguide 927a, and an edge coupler 922 are respectively formed on one side of the optical demodulator.

In some embodiments, a soldering portion 910b is formed on the surface of the first groove 912; and the end of the optical demodulator 921 is fixedly connected to the soldering portion 910b, thereby fixing the optical demodulator 921 to the surface of the first groove 912.

In some embodiments, a metal layer 918a is laid along the top of the optical modulator 911. One end of the metal layer 918a is electrically connected to the optical modulator 911, and the other end thereof is electrically connected to the modulation driver 918, thereby achieving the electrical connection between the modulation driver 918 and the optical modulator 911.

In some embodiments, a fourth groove 917 is formed by etching along the bottom surface of the first substrate 910, and a transimpedance amplifier 919 is formed on the surface of the fourth groove 917. The transimpedance amplifier 919 is electrically connected to the optical demodulator 921.

In some embodiments of the present disclosure, a fabrication process for an optical modulation chip 900 may include respectively fabricating a first optical chip 900a and a second optical chip 900b, and then hybrid-integrating the two chips. In some embodiments, the optical modulation chip 900 is obtained based on evanescent wave coupling passive mounting technology. Due to the evanescent wave coupling passive mounting technology, the first optical chip 900a and the second optical chip 900b can be fabricated simultaneously.

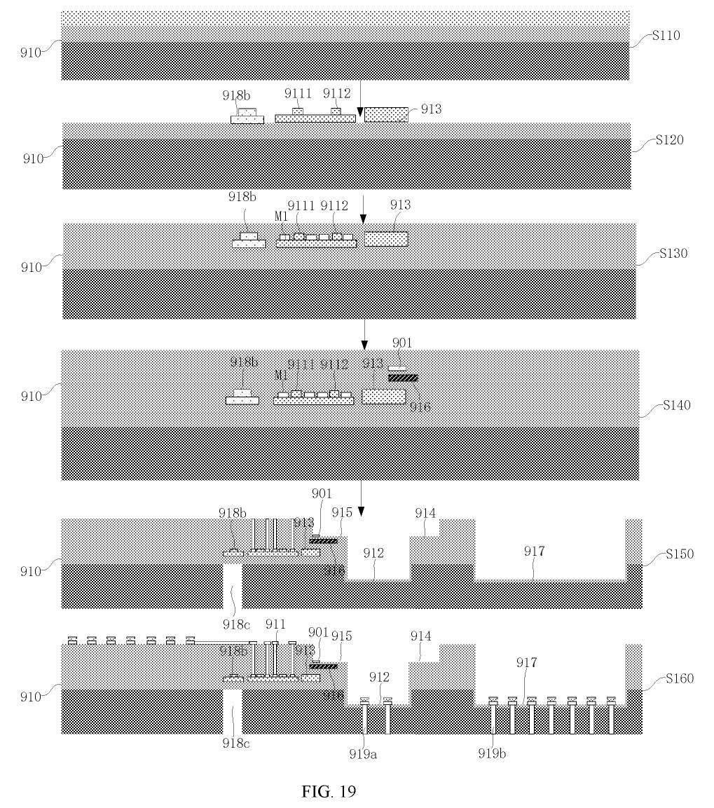

FIG. 19 is a schematic diagram of a fabrication process for a first optical chip according to some embodiments of the present disclosure. As shown in FIG. 19, in some embodiments of the present disclosure, the first optical chip 900a is a thin-film lithium niobate chip.

In some embodiments, a fabrication process for a first optical chip 900a includes the following steps.

In S110, a first substrate is fabricated.

By way of example, the first substrate 910 is a thin-film lithium niobate-based substrate, and the first substrate 910 includes a silicon layer, a silicon oxide layer, and a thin-film lithium niobate layer in sequence from bottom to top. The silicon oxide layer is an intermediate insulating buried layer, which can achieve full dielectric isolation between the first substrate 910 and the device, thereby optimizing the device performance.

In S120, a phase modulator, a ridge waveguide of an optical modulator, and a second coupling waveguide are respectively formed by growth along the surface of a thin-film lithium niobate layer of the first substrate.

In some embodiments, etching is performed on the surface of the thin-film lithium niobate layer of the first substrate to respectively form the phase modulator 918b, the ridge waveguide of the optical modulator 911, and the second coupling waveguide 913. The ridge waveguide of the optical modulator 911 includes a first ridge waveguide 9111 and a second ridge waveguide 9112.

In S130, a silicon oxide layer continues to be deposited on the surface of a silicon oxide layer of the first substrate, and a first metal layer M1 is grown on the surface of the ridge waveguide of the optical modulator.

In some embodiments, a layer of silicon oxide is deposited on the current surface and the first metal layer M1 of the optical modulator 911 is formed; then a silicon oxide layer of a certain thickness is deposited; and the surface is thinned and polished by chemical mechanical polishing.

In S140, a third coupling waveguide and an etch stop layer are formed by growth along the current surface.

In some embodiments, a layer of amorphous silicon is deposited on the surface, and the third coupling waveguide 916 is fabricated by a single electron beam lithography process. By way of example, the third coupling waveguide 916 is located obliquely above the second coupling waveguide 913. Then, silicon oxide of a certain thickness is deposited and a first etch stop layer 901 is deposited thereon. The first etch stop layer 901 is located above the third coupling waveguide 916.

In S150, a second groove, a third groove, a first groove, and a fourth groove are respectively formed by etching along the current surface.

Etching is performed from the surface down to the first etch stop layer 901, and the first etch stop layer 901 is removed by wet etching, thereby forming the second groove 915 and the third groove 914. Then, etching is continued downward from the surface of the second groove 915 for a certain depth to form the first groove 912. The fourth groove 917 is formed by etching downward from the surface of the first substrate 910 on one side of the first groove 912.

By way of example, the second groove 915 and the third groove 914 are respectively formed on both sides of the first groove 912. The first groove 912 is configured to embed the optical demodulator 921. The second groove 915 and the third groove 914 are respectively connected to the first overlapping portion 925 and the second overlapping portion 926 in the second optical chip 900b.

By way of example, the arrangement of the first groove 912, the second groove 915, and the third groove 914 facilitates bringing the second optical chip 900b close to the first optical chip 900a, thereby reducing the size of the optical modulation chip 900 and facilitating chip miniaturization. Furthermore, the arrangement of the second groove 915 shortens the coupling distance between the third coupling waveguide 916 and the corresponding coupling waveguide in the second optical chip, which facilitates optical signal transmission.

By way of example, the surface of the fourth groove 917 is used to dispose the transimpedance amplifier 919. The top surface of the fourth groove 917 is flush with the plane where the top surface of the first groove 912 is located. The transimpedance amplifier 919 is soldered onto the surface of the fourth groove 917 in a flip-chip manner.

In some embodiments, a via is further etched upward along the first metal layer M1 of the optical modulator 911. In some embodiments, the projection region of the phase modulator 918b on the first substrate 910 is hollowed out to form a hollowed-out region 918c.

In S160, a second metal layer of the optical modulator is formed, and a metal layer electrically connecting the optical modulator and the modulation driver is then laid; furthermore, a first via and a second via are formed.

In some embodiments, the via VIA and the second metal layer M2 are grown along the first metal layer M1 to fabricate the optical modulator 911. Furthermore, a metal layer 918a is formed by continuing to lay toward the right side along the second metal layer M2. The optical modulator 911 and the modulation driver 918 are electrically connected via the metal layer 918a. The modulation driver 918 is soldered onto the surface of the metal layer 918a in a flip-chip manner.

In some embodiments, vias are respectively formed downward along the first groove 912 and the fourth groove 917, thereby respectively forming the first via 919a and the second via 919b.

After the above steps, the first optical chip 900a can be fabricated.

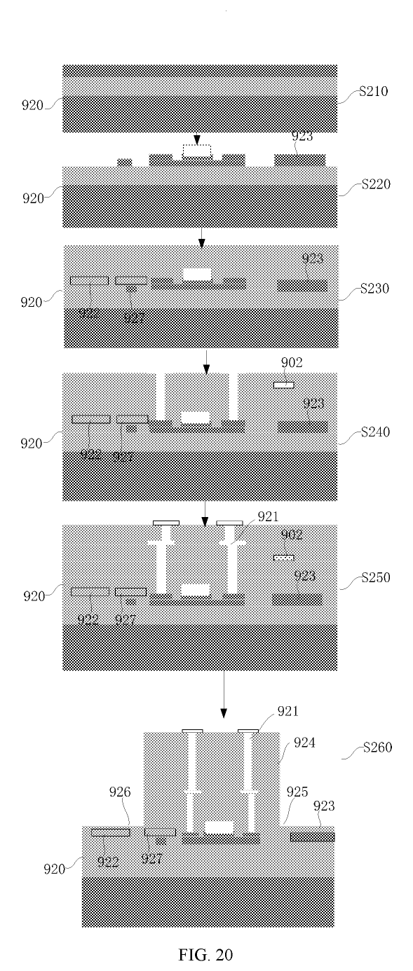

FIG. 20 is a schematic diagram of a fabrication process for a second optical chip according to some embodiments of the present disclosure. As shown in FIG. 20, in some embodiments of the present disclosure, the second optical chip 900b is a silicon photonic chip.

In some embodiments, a fabrication process for a second optical chip 900b includes the following steps.

In S210, a second substrate is fabricated.

By way of example, the second substrate 920 is a silicon-based substrate, and the second substrate 920 includes a first silicon layer, a silicon oxide layer, and a second silicon layer in sequence from bottom to top.

The silicon oxide layer is an intermediate insulating buried layer, which can achieve full dielectric isolation between the second substrate 920 and the device, thereby optimizing the device performance.

In S220, a first coupling waveguide and various functional devices are formed by growth along the surface of a second silicon layer of the second substrate.

In some embodiments, the first coupling waveguide 923 is etched on the surface of the second silicon layer of the second substrate, and the various functional devices are formed by etching, where the various functional devices include devices such as the first optical splitter 9281, the second optical splitter 9282, the third optical splitter 9283, the first mixer 9284, and the second mixer 9285.

Furthermore, a ridge waveguide of an optical demodulator 921 is etched on the surface of the second silicon layer on the second substrate, and an absorber in the optical demodulator 921 is formed by growth on the surface of the ridge waveguide.

In S230, silicon oxide continues to be deposited along the surface of the silicon oxide layer of the second substrate, and an edge coupler and a silicon nitride optical waveguide are fabricated.

In some embodiments, a layer of silicon oxide is deposited on the surface of the silicon oxide layer of the second substrate and polished; then a layer of silicon nitride is deposited, and the surface of the layer of silicon nitride is etched to respectively form the edge coupler 922, the silicon nitride optical waveguide 927, and the silicon waveguide 927a; and then silicon oxide of a certain thickness is deposited on the surface. By way of example, the edge coupler 922 is a silicon nitride edge coupler.

In S240, an etch stop layer is deposited and formed along the current surface, and respective first metal electrode layers of optical detectors are formed.

In some embodiments, a layer of silicon oxide is deposited on the current surface, and the second etch stop layer 902 is formed, while the first metal electrode layer of the optical demodulator 921 and the via between the first metal electrode layer and the second metal electrode layer are formed.

In S250, the respective second metal electrode layers of the optical detectors are formed.

In some embodiments, silicon oxide of a certain thickness is deposited to form the second metal electrode layer for the optical demodulator 921, thereby achieving fabrication of the optical demodulator 921.

In S260, a third recessed portion and a fourth recessed portion are formed by etching.

In some embodiments, etching is performed from the surface until the second etch stop layer 902 is reached, thereby respectively forming a first overlapping portion 925 and a second overlapping portion 926 on both sides. The second etch stop layer 902 is then removed. A protruding portion 924 is formed simultaneously with the first overlapping portion 925 and the second overlapping portion 926.

In some embodiments, the end of the optical demodulator 921 is connected to the soldering portion 910b, thereby fixing the optical demodulator 921 to the surface of the first groove 912.

After the above steps, the second optical chip 900b can be fabricated.

In the embodiments of the present disclosure, according to the first optical chip 900a and the second optical chip 900b fabricated above, the protruding portion 924 of the first optical chip 900a is embedded in the first groove 912, the first overlapping portion 925 overlaps the surface of the second groove 915, and the second overlapping portion 926 overlaps the surface of the third groove 914, such that the second optical chip 900b is brought close to the first optical chip 900a, thereby reducing the height of the optical modulation chip 900 and further reducing the size of the optical modulation chip 900, which facilitates chip miniaturization. Furthermore, the coupling distance between the first coupling waveguide 923 and the second coupling waveguide 913 is shortened, thereby reducing optical loss and facilitating optical signal transmission.

In the embodiments of the present disclosure, the light to be modulated enters the interior of the second optical chip 900b from the corresponding optical port of the edge coupler 922, is transmitted to the interior of the first optical chip 900a sequentially via the silicon nitride optical waveguide 927, the silicon waveguide 927a, the optical waveguide 921a of the optical demodulator 921, the first coupling waveguide 923, the third coupling waveguide 916, and the second coupling waveguide 913, and reaches the optical modulator 911 for optical signal modulation. The modulated optical signal sequentially passes through the second coupling waveguide 913, the third coupling waveguide 916, the first coupling waveguide 923, the optical waveguide 921a of the optical demodulator 921, the silicon waveguide 927a, and the silicon nitride optical waveguide 927, and is then output from the first optical chip 900a via the edge coupler 922.

The optical modulation chip provided by the present disclosure includes a first substrate and a second substrate disposed oppositely. The first substrate includes a first groove, where a second groove and a third groove are respectively formed on both sides of the first groove. The surface of the first substrate is provided with an optical modulator configured for optical signal modulation. A second coupling waveguide is formed on one side of the optical modulator, disposed below the second groove, and configured to receive the light to be modulated and transmit it into the optical modulator for optical signal modulation. The second substrate includes a protruding portion, and a first overlapping portion and a second overlapping portion respectively located on both sides of the protruding portion. The protruding portion is embedded in the first groove, the first overlapping portion overlaps the surface of the second groove, and the second overlapping portion overlaps the surface of the third groove, thereby achieving the connection between the first substrate and the second substrate. An optical demodulator is disposed on the surface of the second substrate and in the protruding portion and is configured to demodulate the optical signal. An edge coupler is formed on one side of the optical demodulator, disposed above the second overlapping portion, and configured to receive the light to be modulated and continue to transmit it. A first coupling waveguide is formed on the other side of the optical demodulator and disposed above the first overlapping portion. One end of the first coupling waveguide is optically connected to the edge coupler, and the other end thereof is optically connected to the second coupling waveguide, so as to receive the light to be modulated output by the edge coupler and transmit the light to be modulated into the second coupling waveguide. According to the optical modulation chip provided by the present disclosure, the light to be modulated is sequentially transmitted via the edge coupler, the optical waveguide of the optical demodulator, the first coupling waveguide, and the second coupling waveguide into the optical modulator for optical signal modulation. The modulated optical signal is output sequentially via the second coupling waveguide, the first coupling waveguide, and the edge coupler.

In the optical modulation chip provided by the present disclosure, by way of example, the first substrate is a thin-film lithium niobate-based substrate, and the second substrate is a silicon-based substrate. Since the thin-film lithium niobate has high modulation efficiency, an optical modulator is disposed on the surface of the first substrate. Since the surface of the silicon-based substrate facilitates integration of various functional devices, an optical demodulator is disposed on the surface of the second substrate. The optical modulation chip in the present disclosure is hybrid-integrated with the first substrate and the second substrate, and the optical modulator and the optical demodulator are respectively disposed on the surfaces of the first substrate and the second substrate, thereby giving full play to the advantages of the two substrates and improving the modulation and demodulation performance of the optical module. Furthermore, optical signal transmission between the first substrate and the second substrate is achieved via the edge coupler, the first coupling waveguide, and the second coupling waveguide.

The above descriptions are merely specific embodiments of the present disclosure, but the scope of protection of the present disclosure is not limited thereto. Any of those skilled in the art can think of changes or substitutions within the technical scope of the present disclosure, and these changes or substitutions shall all be included within the scope of protection of the present disclosure. Therefore, the scope of protection of the present disclosure shall be subject to the scope of protection of the claims.

What is claimed is:

1. An optical module, comprising:
a circuit board; and
an optical modulation chip, electrically connected to the circuit board, and the optical modulation chip comprising:
a first substrate, comprising a first groove;
an optical modulator, disposed on a surface of the first substrate and configured to modulate light to be modulated based on an electrical signal;
a second coupling waveguide, disposed on one side of the optical modulator and configured to transmit the light to be modulated to the optical modulator;
a modulation driver, disposed on the other side of the optical modulator, electrically connected to the optical modulator, and configured to process the electrical signal;
a transimpedance amplifier, disposed on the surface of the first substrate;
a second substrate, at least partially embedded in the first groove;
an optical demodulator, disposed on the second substrate, wrapped by the first groove, and configured to demodulate an optical signal, wherein the optical demodulator is disposed on one side of the transimpedance amplifier and electrically connected to the transimpedance amplifier; and
a first coupling waveguide, disposed on one side of the optical demodulator, optically connected to the second coupling waveguide, and configured to transmit the light to be modulated to the second coupling waveguide,
wherein a first via is formed through the first substrate in a direction from an end of the optical demodulator toward the circuit board to electrically connect the optical demodulator to the circuit board;
a second via is formed through the first substrate in a direction from a bottom surface of the transimpedance amplifier toward the circuit board to electrically connect the transimpedance amplifier to the circuit board; and
the first via and the second via are electrically connected through a trace in the circuit board.

2. The optical module according to claim 1, wherein the first via is provided with a first connection portion on a surface of the circuit board, and the second via is provided with a second connection portion on the surface of the circuit board; and the optical demodulator is connected to the transimpedance amplifier by connecting the first connection portion to the second connection portion.

3. The optical module according to claim 1, wherein a second groove and a third groove are respectively formed on both sides of the first groove; and
the second substrate comprises a protruding portion, a first overlapping portion, and a second overlapping portion, the protruding portion is embedded in the first groove, the first overlapping portion overlaps a surface of the second groove, and the second overlapping portion overlaps a surface of the third groove.

4. The optical module according to claim 1, wherein the modulation driver is formed on the surface of the first substrate; the modulation driver is located on one side of the optical modulator; and
a metal layer is laid along a top of the optical modulator, one end of the metal layer is electrically connected to the optical modulator, and the other end of the metal layer is electrically connected to the modulation driver, thereby achieving an electrical connection between the modulation driver and the optical modulator.

5. The optical module according to claim 1, wherein the modulation driver is disposed on one side of the optical modulator, and the optical modulator comprises a first ridge waveguide, a second ridge waveguide, a first differential modulation electrode, a second differential modulation electrode, a third differential modulation electrode, and a fourth differential modulation electrode;
the first differential modulation electrode is located on one side of the first ridge waveguide, the second differential modulation electrode and the third differential modulation electrode are located between the first ridge waveguide and the second ridge waveguide, and the fourth differential modulation electrode is located on one side of the second ridge waveguide; and
a first differential output terminal of the modulation driver is respectively electrically connected to the first differential modulation electrode and the fourth differential modulation electrode, and a second differential output terminal of the modulation driver is respectively electrically connected to the second differential modulation electrode and the third differential modulation electrode.

6. The optical module according to claim 1, wherein an effective refractive index of the first coupling waveguide is greater than that of the second coupling waveguide;
a width of the first coupling waveguide gradually decreases in a direction from a light input end of the first coupling waveguide to a light output end thereof, such that the light to be modulated is coupled from the first coupling waveguide into the second coupling waveguide; and
a width of the second coupling waveguide gradually increases in a direction from a light input end of the second coupling waveguide to a light output end thereof to receive light output from the first coupling waveguide.

7. The optical module according to claim 6, wherein a third coupling waveguide is further formed on the surface of the first substrate, the third coupling waveguide is disposed between the first coupling waveguide and the second coupling waveguide, one end of the third coupling waveguide is optically connected to the first coupling waveguide, and the other end of the third coupling waveguide is optically connected to the second coupling waveguide; and
the third coupling waveguide is provided with a grating for light splitting.

8. The optical module according to claim 7, wherein the third coupling waveguide comprises a first tapered region and a second tapered region, the first tapered region faces the first coupling waveguide, and the second tapered region faces the second coupling waveguide;
the width of the first coupling waveguide gradually decreases in the direction from the light input end of the first coupling waveguide to the light output end thereof, and a width of the first tapered region gradually increases in a direction from a light input end of the first tapered region to a light output end thereof, such that the light to be modulated is coupled from the first coupling waveguide into the first tapered region; and
a width of the second tapered region gradually decreases in a direction from a light input end of the second tapered region to a light output end thereof, and the width of the second coupling waveguide gradually increases in the direction from the light input end of the second coupling waveguide to the light output end thereof, such that the light to be modulated is coupled from the second tapered region into the second coupling waveguide.

9. The optical module according to claim 1, wherein an edge coupler is formed on one side of the first coupling waveguide, and a silicon nitride optical waveguide is formed between the edge coupler and the first coupling waveguide; and the edge coupler comprises:
an optical output port, coupled to the optical modulator and configured to output a modulated optical signal;
a first optical input port, respectively coupled to the optical modulator and the optical demodulator and configured to receive the light to be modulated; and
a second optical input port, coupled to the optical demodulator and configured to receive an external optical signal.

10. The optical module according to claim 9, wherein a silicon waveguide is formed on one side of the silicon nitride optical waveguide, and the silicon waveguide is configured to enable optical signal transmission between the silicon nitride optical waveguide and an optical waveguide of the optical demodulator; and
the silicon waveguide, the optical waveguide of the optical demodulator, and the first coupling waveguide are coplanar.

11. The optical module according to claim 1, wherein a fourth groove is formed on one side of the optical demodulator; and
the transimpedance amplifier is disposed on a surface of the fourth groove.

12. The optical module according to claim 1, wherein the second coupling waveguide is formed on one side of the optical modulator, and a phase modulator is formed on the other side of the optical modulator; and a hollowed-out region is formed in a region of the first substrate opposite to the phase modulator.

13. The optical module according to claim 12, wherein the phase modulator is configured to change a temperature of one modulation arm of the optical modulator by heating to adjust an operating point of the optical modulator; and the hollowed-out region is configured to reduce dissipation of heat from the phase modulator to the first substrate to improve the phase adjustment efficiency of the optical modulator.

14. The optical module according to claim 11, wherein a distance from the fourth groove to a bottom surface of the first substrate is the same as that from the first groove to the bottom surface of the first substrate, and a top surface of the fourth groove and a top surface of the first groove are coplanar.

15. The optical module according to claim 9, wherein a first optical splitter, a second optical splitter, a third optical splitter, and a first mixer are integrated on the second substrate,
the first optical splitter is configured to decompose the light to be modulated into local oscillator light and a transmitter light source, and the local oscillator light remains in an optical regulator and is configured for coherent demodulation of the optical signal; the transmitter light source is transmitted along the first coupling waveguide and coupled into the second coupling waveguide at a light output end of the second substrate until the light source is transmitted into the optical modulator for optical signal modulation;
the third optical splitter is configured to split the local oscillator light into first transverse electric (TE) polarized light and first transverse magnetic (TM) polarized light;
the second optical splitter is configured to decompose the external optical signal into second TE polarized light and second TM polarized light;
the first mixer is configured to mix and amplify the first TE polarized light with the second TE polarized light to obtain first mixed light; and
the first mixed light is converted into a corresponding electrical signal via the optical demodulator.

16. The optical module according to claim 15, wherein a second detector is further integrated on the second substrate, and the second detector is configured to monitor power of the received optical signal.

17. The optical module according to claim 6, wherein the first coupling waveguide has a cross section transitioning from a rectangular waveguide to a tapered waveguide, and the first coupling waveguide is coupled to an edge coupler on one side of the rectangular waveguide and the second coupling waveguide on one side of the tapered waveguide.

18. The optical module according to claim 1, wherein the optical modulation chip comprises a first optical chip and a second optical chip;
the first substrate, the optical modulator, and the second coupling waveguide are integrated in the first optical chip; and
the second substrate, the optical demodulator, and the first coupling waveguide are integrated in the second optical chip.

19. The optical module according to claim 1, wherein the first substrate is a thin-film lithium niobate-based substrate, and the thin-film lithium niobate-based substrate comprises a silicon layer, a first silicon oxide layer, and a thin-film lithium niobate layer that are stacked.

20. The optical module according to claim 1, wherein the second substrate is a silicon-based substrate, and the silicon-based substrate comprises a first silicon layer, a silicon oxide layer, and a second silicon layer that are stacked.
